(19) United States
(12) Patent Application Publication
(10) Pub. No.: US 2007/0247599 A1
(43) Pub. Date: Oct. 25, 2007

(54) Projector Having Variable Throw Distance for Variable Magnification

(75) Inventors: Seijiro KADOWAKI, Nagoya-shi (JP); Hiroshi UCHIGASHIMA, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/769,360

(22) Filed: Jun. 27, 2007

Related U.S. Application Data
(63) Continuation-in-part of application No. PCT/JP05/23705, filed on Dec. 26, 2005.

(30) Foreign Application Priority Data
Dec. 28, 2004 (JP) 2004378812
Dec. 28, 2004 (JP) 2004378412

(51) Int. Cl. G03B 3/00

(52) U.S. Cl. 353/101

(57) ABSTRACT

There is disclosed a projector supportable on a support surface which is defined as at least a surface coplanar with or parallel to a projection surface, for use in projecting imaging light representative of a display image onto the projection surface, to thereby display the display image on the projection surface. The projector includes: a projection device arranged to project the imaging light toward the projection surface, to thereby focus the image onto the projection surface as a projected image; and a supporting device arranged, when placed on the support surface, to support the projection device such that a distance between an exit face at which the imaging light exits the projection device and the projection surface is adjustable.

### CROSS-REFERENCE TO RELATED APPLICATIONS

This application is based on Japanese Patent Applications No. 2004-378812 filed Dec. 28, 2004 and No. 2004-378412 filed Dec. 28, 2004, and International Application No. PCT/JP2005/023705 filed Dec. 26, 2005, the contents of which are incorporated hereinto by reference.

This application is a continuation-in-part application of International Application No. PCT/JP2005/023705 filed Dec. 26, 2005, now pending, which was published in Japanese under PCT Article 21(2).

### BACKGROUND OF THE INVENTION

1. Field of the Invention

The invention relates generally to projectors which, in use, are supportable on a support surface defined as at least a surface coplanar with or parallel to a projection surface, and more particularly to improved techniques of allowing the projectors to zoom (i.e., enlarge/reduce) a projected image produced by the projectors.

2. Description of the Related Art

There are known projectors as technical devices for producing optical representation of images. Such projectors may be used in a person's home as a television, a slide projector, a video projector, a computer monitor, a home-entertainment system, etc., and alternatively may be used in a business environment.

Such projectors are typically configured to project imaging light representative of a display image onto a projection surface, to thereby display the display image on the projection surface.

Ones of such projectors are categorized as projectors which, in use, are supportable on a support surface defined as at least a surface coplanar with or parallel to a projection surface. The surface coplanar with or parallel to a projection surface may include the top of a desk, the top of a table, a wall surface of a room, the surface of a room ceiling, etc.

Notably, a projector supportable on an up-facing horizontal surface, such as the top of a desk, or the top of a table, is referred in the art to a tabletop (or table-mounted) or desktop (or desk-mounted) projector. An exemplary conventional version of such a projector is disclosed in Japanese Patent Application Publication No. 2003-280091.

Within such tabletop projectors, there are known multiple-surface display projectors which, in use, are supportable on an additional support surface which is neither coplanar with nor parallel to a projection surface.

Such projectors can be placed on a surface coplanar with or parallel to the projection surface, and also can be alternatively placed on a surface which is neither coplanar with nor parallel to the projection surface. Placement of a projector on a surface which is neither coplanar with nor parallel to the projection surface means, for example, placement of a projector on a horizontal tabletop in a room, which is adapted to project imaging light onto a wall surface of the room.

Such a projector is configured, in general, to include (a) a projection device arranged to project imaging light toward a projection surface, to thereby focus a display image onto the projection surface as a projected image; and (b) a supporting device arranged, when placed on a support surface, to support the projection device.

It would be desirable to provide a projector with a zoom function without making an optical system within the projector more complex in structure.

### BRIEF SUMMARY OF THE INVENTION

In general, the invention relates to techniques of allowing projectors to zoom (i.e., enlarge/reduce) a projected image produced by the projectors.

According to some aspects of the invention, there is provided a projector supportable on a support surface which is defined as at least a surface coplanar with or parallel to a projection surface, for use in projecting imaging light representative of a display image onto the projection surface, to thereby display the display image on the projection surface.

This projector may be configured to include:

a projection device arranged to project the imaging light toward the projection surface, to thereby focus the image onto the projection surface as a projected image; and

a supporting device arranged, when placed on the support surface, to support the projection device such that a distance between an exit face at which the imaging light exits the projection device and the projection surface is adjustable.

It is noted here that, as used in this specification, the singular form “a,” “an,” and “the” include plural reference unless the context clearly dictates otherwise. It is also noted that the terms “comprising,” “including,” and “having” can be used interchangeably.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a side view partly in section illustrating a tabletop projector 10 constructed according to a first illustrative embodiment of the present invention;

FIG. 2 is a schematic block diagram illustrating an assemblage optical system 32 and a control unit 34 each depicted in FIG. 1;

FIG. 3 is a perspective view illustrating the tabletop projector 10 depicted in FIG. 1, with a projection device 20 being in a lower-most position;

FIG. 4 is a side view partly in section illustrating the tabletop projector 10 depicted in FIG. 3;

FIG. 5 is a perspective view illustrating the tabletop projector 10 depicted in FIG. 1, with the projection device 20 being in an intermediate position between the lower-most position and an upper-most position;

FIG. 6 is a side view partly in section illustrating the tabletop projector 10 depicted in FIG. 5;

FIG. 7 is a side view for explanation of how to use a tabletop projector 154 constructed according to a second illustrative embodiment of the present invention;

FIG. 8 is a side view for explanation of how to use a tabletop projector 162 constructed according to a third illustrative embodiment of the present invention;

FIG. 9 is a side view partly in section illustrating a tabletop projector 210 constructed according to a fourth illustrative embodiment of the present invention;

FIG. 10 is a schematic block diagram illustrating an assemblage optical system 32 and a control unit 34 each depicted in FIG. 9;

FIG. 11 is a sectional side view illustrating a distance detecting device 230 depicted in FIG. 10;

FIG. 12 is a flow chart conceptually illustrating an automatic focusing program to be executed by a computer 172 depicted in FIG. 10;

FIG. 13 is a side view illustrating a tabletop projector 300 constructed according to a fifth illustrative embodiment of the present invention;

FIG. 14 is a sectional side view illustrating a projection device 20 depicted in FIG. 13;

FIG. 15 is a side view illustrating a tabletop projector 340 constructed according to a sixth illustrative embodiment of the present invention;

FIG. 16 is a side view illustrating a tabletop projector 380 constructed according to a seventh illustrative embodiment of the present invention;

FIG. 17 is a side view illustrating a tabletop projector 420 constructed according to an eighth illustrative embodiment of the present invention;

FIG. 18 is a side view illustrating a tabletop projector 460 constructed according to a ninth illustrative embodiment of the present invention;

FIG. 19 is a side view illustrating a tabletop projector 500 constructed according to a tenth illustrative embodiment of the present invention with a projection device 20 being in a position for projecting an image onto a horizontal screen 14;

FIG. 20 is a side view illustrating the tabletop projector 500 depicted in FIG. 19, with the projection device 20 being in a position for projecting an image onto a vertical screen 14;

FIG. 21 is a side view illustrating a tabletop projector 540 constructed according to an eleventh illustrative embodiment of the present invention, with a projection device 20 being in a lower-most position;

FIG. 22 is a side view illustrating the tabletop projector 540 depicted in FIG. 21, with the projection device 20 being in an upper-most position; and

FIG. 23 is a side view illustrating a tabletop projector 580 constructed according to a twelfth illustrative embodiment of the present invention.

### DETAILED DESCRIPTION OF THE INVENTION

According to the invention, there are provided the following modes as illustrative embodiments of the invention.

These modes will be stated below so as to be sectioned and numbered, and so as to depend upon the other mode or modes, where appropriate. This is for a better understanding of some of a plurality of technical features and a plurality of combinations thereof disclosed in this description, and does not mean that the scope of these features and combinations is interpreted to be limited to the scope of the following modes of this invention.

That is to say, it should be interpreted that it is allowable to select the technical features which are stated in this description but which are not stated in the following modes, as the technical features of this invention.

Furthermore, stating each one of the modes of the invention in such a dependent form as to depend from the other mode or modes does not exclude the possibility that the technical features set forth in a dependent-form mode become independent of those set forth in the corresponding depended mode or modes and to be removed therefrom. It should be interpreted that the technical features set forth in a dependent-form mode are allowed to become independent, where appropriate.

(1) A projector supportable on a support surface which is defined as at least a surface coplanar with or parallel to a projection surface, for use in projecting imaging light representative of a display image onto the projection surface, to thereby display the display image on the projection surface, the projector comprising:

a projection device arranged to project the imaging light toward the projection surface, to thereby focus the image onto the projection surface as a projected image; and

a supporting device arranged, when placed on the support surface, to support the projection device such that a distance between an exit face at which the imaging light exits the projection device and the projection surface is adjustable.

A need exits for a so-called zoom feature (which allows variation of the size of a projected image to be displayed on a projection surface), in such projectors that, in use, are supportable on a support surface which is defined as at least a surface coplanar with or parallel to a projection surface, as well as other typical projectors.

Conventionally, the above-stated need is met by adding a zoom optical system to a projector, to thereby cause an optical system (e.g., lens group) of a projection device (i.e., a projector in a narrow sense) itself which is incorporated in the projector (i.e., an assemblage projector system in a narrow sense), to provide an optical function to zoom.

In the absence of the need to add a zoom feature to a projection device (i.e., a projector in a narrow sense) incorporated in a projector (i.e., an assemblage projector system in a narrow sense), the projector may be constructed such that the projection device uses an optical system having no zoom function, resulting in simplified design of the optical system in the projector.

In contrast, in the presence of the need to add a zoom feature to a projection device (i.e., a projector in a narrow sense) incorporated in a projector (i.e., an assemblage projector system in a narrow sense), conventional projectors tend to require a complicated design of their optical systems.

The projector constructed according to the present mode has been proposed for providing with a zoom function, a projector which, in use, is supportable on a support surface which is defined as at least a surface coplanar with or parallel to a projection surface, without making an optical system incorporated in the projector complicated in structure.

This projector allows a distance between the exit face at which imaging light exits the projection device, and the projection surface, to be adjustable. The distance will be hereinafter referred to as “projection distance,” which may be used interchangeably with a throw distance.

On the other hand, in general, the longer the projection distance, the larger the size of a projected image, even though imaging light emitted from the projection device is kept fixed in optical properties (e.g., the focal length of the imaging light is kept fixed) This is called image extension.

As a result, the size of the projected image varies depending on the projection distance that the projection device is relative to the projection surface. In other words, changes in the projection distance produce a zoom feature for this projector.

This projector, therefore, would achieve a zoom function for a projected image, without relying on any additional optical feature provided by the projection device.

An example of this projector may be configured to use an optical system incapable of providing its projection device itself with a zoom function. This example makes it easier to simplify the design of the optical system of the projection device, than when, for the projector to achieve a zoom function, its projection device is required to be configured to provide a zoom function by the projection device itself.

(2) The projector according to mode (1), wherein the projection device is configured to include a focusing optical system arranged to focus the projected image onto the projection surface using optical properties of the focusing optical system, the optical properties including such deep depth-of-field that allows the projected image to be substantially maintained in viewer-acceptable focus over a full adjustable-range of the distance.

This projector prevents the projected image from becoming blurry due to adjustment of the projection distance, resulting in no required adjustment of the focus of the projected image during adjustment of the projection distance.

This projector, therefore, makes it still easier to simplify the structure of this projector.

(3) The projector according to mode (1), wherein the projection device is configured to include a focus adjuster arranged to optically adjust focus of the projected image, and the projector further comprises a controller arranged to control the focus adjuster based on the distance, to thereby automatically adjust the focus of the projected image.

In general, for a projector using a projection device having shallow depth-of-field, a change in the projection distance made in a direction bringing a projected image into out-of-focus, easily causes the projected image to appear blurry.

In contrast, the projector constructed according to the present mode allows the focus of the projected image to be automatically adjusted depending on a value of the projection distance.

This projector, therefore, prevents the projected image from becoming blurry due to any adjustment of the projection distance for alternation of the size of the projected image.

(4) The projector according to mode (3), wherein the focus adjuster is electrically powered, and the controller is arranged to electrically detect the distance and electrically control the focus adjuster based on the detected distance.

This projector allows the focus adjuster to be electrically controlled based on the detected value of the projection distance, to thereby automatically adjust the focus of the projected image.

This projector, therefore, allows the focus of the projected image to be automatically adjusted, while monitoring an actual value of the projection distance, resulting in greater ease with which the focus adjustment is performed with improved accuracy.

The “controller” set forth in the present mode may be configured so as to detect a value of the projection distance step-wise or continuously, by the use of at least one sensor (e.g., optical, electrical, magnetic types, etc.), for detection of the projection distance, which is adapted to generate an output signal variable in state in more-than-two-step as a function of the value of the projection distance.

Alternatively, the “controller” set forth in the present mode may be configured so as to detect a value of the projection distance in two-step or more-than-two-step, by the use of one or more switches (which are also categorized as sensors in a broad sense), for detection of the projection distance, each of which is adapted to generate an output signal variable in state in two-step as a function of the value of the projection distance.

(5) The projector according to mode (3), wherein the focus adjuster is mechanically powered, and the controller is arranged to transfer to the focus adjuster, a relative mechanical-movement between a stationary member and a movable portion of the projector which moves as the distance changes, to thereby automatically adjust the focus of the projected image.

This projector allows the focus adjuster to be mechanically powered, by the utilization of the relative mechanical-movement between the stationary member and the movable portion of this projector which moves as the projection distance changes, to thereby automatically adjust the focus of the projected image.

This projector, therefore, allows the focus of the projected image to be automatically adjusted, while monitoring an actual value of the projection distance, resulting in greater ease with which the focus adjustment is performed with improved accuracy.

The “stationary member” set forth in the present mode may be interpreted to mean, for example, a portion of this projector which does not move with changes in the projection distance, an object located around this projector (e.g., a desk, a table, a room wall, etc.), or the like.

In addition, the “movable member” set forth in the present mode may be interpreted to mean, for example, the projection device, a portion of the supporting device which moves as the projection distance changes, or the like.

The “controller” set forth in the present mode may be implemented, for example, such that a rectilinear relative movement which occurs between the stationary member and the movable member, depending on changes in the projection distance, is converted into a rotational motion by means of a rotary member such as one or more gears, and such that the resulting rotational motion is transferred to the focus adjuster, without any conversion or after conversion into a rectilinear motion, to thereby cause the focus adjuster to operate so as to adjust the focus of the projected image.

(6) The projector according to any one of modes (1)-(5), used in a position allowing an optical axis of the imaging light exiting the projection device to be oriented perpendicular to the projection surface.

(7) The projector according to any one of modes (1)-(6), wherein the supporting device is configured to include a base which is to be placed on the support surface and support the projection device, when the base is placed on the support surface, such that the base and the projected image are arrayed on the support surface so as to be closely spaced from each other.

This projector would provide the same functions and effects as those of a projector according to mode (17) which will be described in greater detail later on.

(8) The projector according to mode (7), wherein the supporting device is configured to include:

the base to be placed on the support surface; and

a strut extending out from the base, and

the strut is arranged to support the projection device, when the base is placed on the support surface, such that the base and the projected image are arrayed on the support surface so as to be closely spaced from each other.

This projector would provide the same functions and effects as those of a projector according to mode (19) which will be described in greater detail later on.

(9) The projector according to mode (8), wherein the support surface is defined as a horizontal surface, and the strut is configured to extend from the base to the projection device and support the projection device in a position allowing a center of gravity of the projection device to be located on a center line of the strut.

This projector would provide the same functions and effects as those of a projector according to mode (20) which will be described in greater detail later on.

(10) The projector according to mode (8), wherein the support surface is defined as a horizontal surface,

the projection device is configured to extend along the support surface and include a front-side portion from which the imaging light is emitted and a rear-side portion, and

the strut is configured to extend from the base to the projection device and support the projection device in a position allowing the center of gravity of the projection device to be located, when viewed in plan view, on the same side as the front-side portion of the projection device, with respect to a connection point between the projection device and the strut.

This projector would provide the same functions and effects as those of a projector according to mode (21) which will be described in greater detail later on.

(11) The projector according to mode (8), wherein the support surface is defined as a horizontal surface,

the projection device is configured to extend along the support surface and include a front-side portion from which the imaging light is emitted and a rear-side portion, and

the strut is configured to extend from the base to the projection device so as to be inclined toward the front-side portion of the projection device with respect to a normal to the support surface, the strut being arranged to support the projection device in a position allowing the center of gravity of the projection device to be located, when viewed in plan view, on the same side as the rear-side portion of the projection device, with respect to a connection point between the projection device and the strut.

This projector would provide the same functions and effects as those of a projector according to mode (22) which will be described in greater detail later on. (12) The projector according to mode (8), wherein the support surface is defined as a horizontal surface,

the projection device is configured to extend along the support surface and include a front-side portion from which the imaging light is emitted and a rear-side portion, and

the strut is configured to extend from the base to the projection device so as to be inclined toward the rear-side portion of the projection device with respect to a normal to the support surface, the strut being arranged to support the projection device in a position allowing the center of gravity of the projection device to be located, when viewed in plan view, on the same side as the rear-side portion of the projection device, with respect to a connection point between the projection device and the strut.

This projector would provide the same functions and effects as those of a projector according to mode (23) which will be described in greater detail later on.

(13) The projector according to mode (8), wherein the support surface is defined as a horizontal surface,

the projection device is configured to extend along the support surface and include a front-side portion from which the imaging light is emitted and a rear-side portion, and

the strut is configured to extend from the base to the projection device so as to be parallel to a normal to the support surface, the strut being arranged to support the projection device in a position allowing the center of gravity of the projection device to be located, when viewed in plan view, on the same side as the rear-side portion of the projection device, with respect to a connection point between the projection device and the strut.

This projector would provide the same functions and effects as those of a projector according to mode (24) which will be described in greater detail later on.

(14) The projector according to any one of modes (7)-(13), wherein the projection device is arranged to project the imaging light such that a portion of the imaging light emitted from the projection device, which portion is proximate to the base, is projected from the projection device onto the projection surface perpendicularly.

This projector would provide the same functions and effects as those of a projector according to mode (25) which will be described in greater detail later on.

(15) The projector according to any one of modes (7)-(14), further comprising a tilt mechanism configured to pivotably couple the projection device to the strut.

This projector would provide the same functions and effects as those of a projector according to mode (26) which will be described in greater detail later on.

(16) The projector according to any one of modes (7)-(15), wherein the projection device is configured to extend along the support surface and include a front-side portion from which the imaging light is emitted and a rear-side portion, and

the base is configured to include a main body and a movable member disposed at a front end portion of the main body which is proximate to the projected image, the movable member being movable relative to the main body in a front-to-rear direction of the projection device.

This projector would provide the same functions and effects as those of a projector according to mode (27) which will be described in greater detail later on.

(17) A projector for use in projecting imaging light representative of a display image onto a projection surface, to thereby display the display image on the projection surface, the projector comprising:

a projection device arranged to project the imaging light toward the projection surface, to thereby focus the image onto the projection surface as a projected image; and

a supporting device configured to include a base which is to be placed on the support surface and support the projection device, when the base is placed on the support surface, such that the base and the projected image are arrayed on the support surface so as to be closely spaced from each other.

In general, the above-described tabletop projector is configured to operate, with the projector being placed on a support surface, to emit imaging light representative of an image in the form of divergent light, toward a display screen (may be in the form of a dedicated screen (e.g., a conventional screen) or an alternative screen (e.g., a wall or ceiling surface)), to thereby project the image onto the screen in enlargement.

For this reason, the use of such a projector requires both an area of the support surface which is to be occupied by a base of a supporting device of the projector, and an area of the support surface which is to be occupied by a projected image (i.e., the area of a projected image), to be ensured on the support surface. This typically leads to the requirement that one continuous region of the support surface is ensured to cover those two areas.

Although it is of course appreciated that the continuous region increases in size as the base of the supporting device of such a projector and/or the projected image increase in size, the continuous region increases as the base and the projected image move apart from each other.

On the other hand, because of the dependency of the size of the continuous region upon the size of the support surface on which the projector is to be placed, shortage of the size of the support surface disables an image to be projected with an adequately large magnification scale.

In light of the above circumstances, the invention according to the present mode is directed to a projector configured to allow the size of a continuous region of a support surface on which the projector is to be placed, to be small for the desired size of a projected image.

In this regard, the projector is for use in projecting imaging light representative of a display image onto a projection surface, to thereby display the display image on the projection surface. The continuous region is to be occupied by the projector for enabling the projector to project an image onto the projection surface as a projected image, and is necessarily ensured on the support surface for image projection.

The projector according to the present mode is configured to include a projection device for projecting an image onto a projection surface as a projected image, and a supporting device which is to be placed on a support surface for supporting the projection device.

The supporting device is arranged to include a base which is to be placed on the support surface and support the projection device, when the base is placed on the support surface, such that the base and the projected image are arrayed on the support surface so as to be closely spaced from each other.

In other words, for this projector, the relative geometry between the projection device and the supporting device and the profile of the supporting device are selected to allow the base and the projected image to be arrayed on the support surface so as to be closely spaced from each other.

This projector, therefore, allows the size of a continuous region of the support surface, which is to be occupied by this projector for enabling this projector to project an image onto the projection surface as a projected image, and which is necessarily ensured on the support surface for image projection, to be small for the desired size of the projected image.

This projector, as a result, can be placed on a support surface having a smaller size than that required for conventional projectors, for a viewer-user to view a projected image having a given size. It follows that this projector allows the user to view a projected image having a larger size than a conventional size of the projected image (i.e., a projected image formed with a larger magnification scale than a conventional scale), with this projector being placed on the support table having a given size.

(18) The projector according to mode (17), wherein the projection surface is defined as a plane coplanar with or parallel to the support surface.

Although the projector according to the previous mode (17) may be configured to be usable in a fashion that an image is projected on a projection surface which is neither coplanar with nor parallel to the support surface, the projector according to the present mode is used in a fashion that an image is projected on a projection surface which at least includes a surface which is coplanar with or parallel to the support surface.

The projector according to the present mode, therefore, allows the size of a continuous region of the support surface, which is to be occupied by this projector for enabling this projector to project an image onto the projection surface as a projected image, and which is necessarily ensured on the support surface for image projection, to be small for the desired size of the projected image, as described above for the previous mode (17).

(19) The projector according to mode (17) or (18), wherein the supporting device is configured to include:

a base to be placed on the support surface; and

a strut extending out from the base,

wherein the strut is arranged to support the projection device, when the base is placed on the support surface, such that the base and the projected image are arrayed on the support surface so as to be closely spaced from each other.

In this projector, the supporting device is configured to include the base and the strut which extends out from the base and which supports the projection device. The thus-configured supporting device allows the size of a continuous region of the support surface, which is to be occupied by this projector for enabling this projector to project an image onto the projection surface as a projected image, and which is necessarily ensured on the support surface for image projection, to be small for the desired size of the projected image.

(20) The projector according to mode (19), wherein the support surface is defined as a horizontal surface, and

the strut is configured to extend from the base to the projection device and support the projection device in a position allowing a center of gravity of the projection device to be located on a center line of the strut.

This projector allows a bending moment acting on the strut caused by the weight of the projection device to be reduced relative to that to be caused if the center of gravity of the projection device is deviated from the center line of the strut.

This projector, therefore, allows a bending moment which the strut is required to resist, to be reduced with ease, resulting in the facilitated reduction in the manufacturing cost of the strut and the facilitated relaxation of the constraints in the design (including exterior design) of the strut.

This projector may be constructed, for example, in a fashion that the strut extends vertically or obliquely from the base to the projection device.

(21) The projector according to mode (19), wherein the support surface is defined as a horizontal surface,

the projection device is configured to extend along the support surface and include a front-side portion from which the imaging light is emitted and a rear-side portion, and

the strut is configured to extend from the base to the projection device and support the projection device in a position allowing the center of gravity of the projection device to be located, when viewed in plan view, on the same side as the front-side portion of the projection device, with respect to a connection point between the projection device and the strut.

This projector makes it easier to extend a forward overhang of the front-side portion of the projection device, from the base, when viewed in plan view. As the overhang becomes longer, it becomes easier to ensure or create wide space between the front-side portion of the projection device and the support surface, so as to extend from the front-side portion of the projection device toward the support surface.

This arrangement makes it easier to increase the spread angle of imaging light divergently emitted from the front-side portion of the projection device. On the other hand, an image is projected onto a projection surface with increasing magnification and increasing size, as the spread angle of imaging light increases.

This projector, therefore, makes it easier to project an image with high magnification for the distance of the front-side portion of the projection device from the support surface.

(22) The projector according to mode (19), wherein the support surface is defined as a horizontal surface,

the projection device is configured to extend along the support surface and include a front-side portion from which the imaging light is emitted and a rear-side portion, and

the strut is configured to extend from the base to the projection device so as to be inclined toward the front-side portion of the projection device with respect to a normal to the support surface, the strut being arranged to support the projection device in a position allowing the center of gravity of the projection device to be located, when viewed in plan view, on the same side as the rear-side portion of the projection device, with respect to a connection point between the projection device and the strut.

This projector makes it easier to extend a forward overhang of the front-side portion of the projection device, from the base, when viewed in plan view. As the overhang becomes longer, it becomes easier to ensure or create divergent space between the front-side portion of the projection device and the support surface, so as to extend from the front-side portion of the projection device toward the support surface.

This arrangement makes it easier to increase the spread angle of imaging light divergently emitted from the front-side portion of the projection device. On the other hand, an image is projected onto a projection surface with increasing magnification and increasing size, as the spread angle of imaging light increases.

This projector, therefore, makes it easier to project an image with high magnification for the distance of the front-side portion of the projection device from the support surface.

(23) The projector according to mode (19), wherein the support surface is defined as a horizontal surface,

the projection device is configured to extend along the support surface and include a front-side portion from which the imaging light is emitted and a rear-side portion, and

the strut is configured to extend from the base to the projection device so as to be inclined toward the rear-side portion of the projection device with respect to a normal to the support surface, the strut being arranged to support the projection device in a position allowing the center of gravity of the projection device to be located, when viewed in plan view, on the same side as the rear-side portion of the projection device, with respect to a connection point between the projection device and the strut.

This projector makes it easier to move the center of gravity acting on the projection device and the center of gravity acting on the entire projector, closer to the rear-side portion of the projection device (more rearward of an end portion of the base which is proximate to the front-side portion of the projection device) than when the strut alternatively extends vertically from the base to the projection device.

As the center of gravity of the entire projector moves closer to the rear-side portion of the projection device, a counter moment occurs more effectively at this projector due to the gravity of this projector, in a direction allowing the counter moment to cancel a tipping moment causing the projection device to tip forward.

This arrangement, therefore, makes it easier to allow this projector to be supported on the support surface by means of the supporting device incorporating the strut, in a dynamically stabilized fashion. As a result, this projector is more easily prevented from unexpectedly tipping forward.

(24) The projector according to mode (19), wherein the support surface is defined as a horizontal surface,

the projection device is configured to extend along the support surface and include a front-side portion from which the imaging light is emitted and a rear-side portion, and

the strut is configured to extend from the base to the projection device so as to be parallel to a normal to the support surface, the strut being arranged to support the projection device in a position allowing the center of gravity of the projection device to be located, when viewed in plan view, on the same side as the rear-side portion of the projection device, with respect to a connection point between the projection device and the strut.

In this projector, the tendency that the center of gravity of the entire projector moves rearward increases relative to that when the center of gravity of the projection device is alternatively located forward of the connection point between the projection device and the strut which extends vertically from the base to the projection device.

This arrangement, therefore, makes it easier to allow this projector to be supported on the support surface by means of the supporting device incorporating the strut, in a dynamically stabilized fashion. As a result, this projector is more easily prevented from unexpectedly tipping forward.

(25) The projector according to any one of modes (17)-(24), wherein the projection device is arranged to project the imaging light such that a portion of the imaging light emitted from the projection device, which portion is proximate to the base, is projected from the projection device onto the projection surface perpendicularly.

The projector according to any one of the previous modes (17)-(24) may be practiced in an arrangement in which a distance (hereinafter, referred to as “projection distance”) of the projection device from the projection surface is adjustable.

When this arrangement is embodied such that a portion of imaging light which is emitted from the projection device, which portion is proximate to the base, travels obliquely with respect to the projection surface (support surface), an intersection point between the portion and the projection surface (support surface) moves on and along the plane of the projection surface (support surface) with changes in the projection distance.

In this arrangement, as the intersection point moves along the support surface with changes in the projection distance, the relative geometry between a projected image and the base changes on the support surface.

On the other hand, there is a need for locating a front-side end portion of the base which is proximate to the projected image so that the front-side end portion can be prevented from being overlapped with the base over the full adjustable-range of the projection distance.

In addition, as a clearance between the projected image and the base on the support surface becomes larger, the tendency increases that a counter moment fails to occur effectively at the projector due to the gravity of the projector, in a direction allowing the counter moment to cancel a tipping moment causing the projection device to tip forward.

In contrast, in the projector according to the present mode, a portion of the imaging light emitted from the projection device, which portion is proximate to the base, is projected from the projection device onto the projection surface perpendicularly.

This projector, therefore, allows the relative geometry between the projected image and the base on the support surface to be kept fixed irrespective of changes in the projection distance.

Consequently, this projector prevents change in the relative geometry between the projected image and the base on the support surface due to changes in the projection distance, resulting in no creation of an unneeded clearance between the projected image and the base on the support surface due to changes in the projection distance, and no overlap between the projected image and the base.

This projector, therefore, relaxes its exterior design constraints, and prevents its dynamic stability from being degraded due to changes in the projection distance. As a result, this projector allows its ability of preventing the projection device from tipping forward, to be maintained irrespective of changes in the projection distance.

(26) The projector according to any one of modes (17)-(25), further comprising a tilt mechanism configured to pivotably couple the projection device to the strut.

This projector allows an image to be projected in a variable direction. This projector may be practiced in an arrangement in which the projection device is retractable or foldable with respect to the supporting device. This arrangement may be embodied such that the overall height of this projector is smaller when in a folded position (retracted position) than when in an unfolded position (extended position). This arrangement makes it easier to store this projector, when not in use, in a compact fashion.

(27) The projector according to any one of modes (17)-(26), wherein the projection device is configured to extend along the support surface and include a front-side portion from which the imaging light is emitted and a rear-side portion, and

the base is configured to include a main body and a movable member disposed at a front end portion of the main body which is proximate to the projected image, the movable member being movable relative to the main body in a front-to-rear direction of the projection device.

The projector according to any one of the previous modes (17)-(26) may be practiced in an arrangement in which, as described above, the projection distance is adjustable. When this arrangement is embodied such that, as described above, such that a portion of imaging light which is emitted from the projection device, which portion is proximate to the base, travels obliquely with respect to the projection surface (support surface), an intersection point between the portion and the projection surface (support surface) moves on and along the plane of the projection surface (support surface) with changes in the projection distance.

In this arrangement, as described above, as the intersection point moves along the support surface with changes in the projection distance, the relative geometry between a projected image and the base changes on the support surface.

On the other hand, there is a need for locating a front-side end portion of the base which is proximate to the projected image so that the front-side end portion can be prevented from being overlapped with the base over the full adjustable-range of the projection distance.

In addition, as the clearance between the projected image and the base on the support surface becomes larger, the tendency increases that a counter moment fails to occur effectively at the projector due to the gravity of the projector, in a direction allowing the counter moment to cancel a tipping moment causing the projection device to tip forward.

In contrast, in the projector according to the present mode, the base is configured to include a main body and a movable member movable relative to the main body in a front-to-rear direction of the projection device.

The movable member is placed on the support surface, for example, in a fashion that the movable member is at least in part in mechanical contact with the support surface, like the main body. This movable member is further disposed at the front end portion of the main body which is proximate to the projected image. This movable member can be moved to the main body, so as to fill the clearance between the projected image and the main body created by change of the projection distance.

The projector according to the present mode, therefore, allows the relative geometry between the projected image and the base on the support surface to be kept fixed irrespective of changes in the projection distance.

Consequently, this projector prevents its dynamic stability from being degraded due to changes in the projection distance. As a result, this projector allows its ability of preventing the projection device from tipping forward, to be maintained irrespective of changes in the projection distance.

This projector may be practiced, for example, such that the movable member, although not self-deformable, is attached to the main body, so as to be rectilinearly movable in both directions relative to the main body, such that the movable member, although not self-deformable, is attached to the main body, so as to be pivotable in both directions relative to the main body, or such that the movable member, although not self-deformable, is selectively retracted into and extracted from the main body.

Alternatively, this projector may be practiced such that the movable member is configured to self-extend/contract in a returnable manner whether it is due to external force applied or not, to thereby vary the relative geometry between the movable member and the main body.

Several presently preferred embodiments of the invention will be described in more detail by reference to the drawings in which like numerals are used to indicate like elements throughout.

### FIRST ILLUSTRATIVE EMBODIMENT

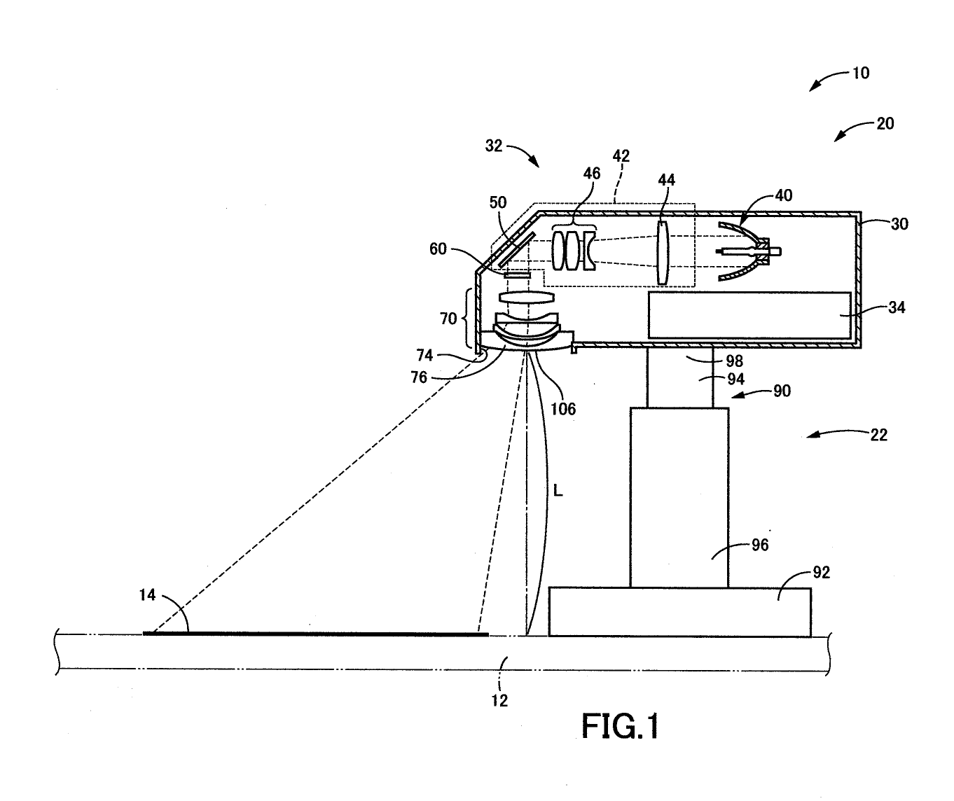

Referring now to FIG. 1, a tabletop or table-mounted projector 10 is illustrated in partially sectional side view, which is constructed according to a first illustrative embodiment of the present invention. The projector 10 is placed on a table 12 for use.

The projector 10, when in use, projects a display image onto a screen 14 placed or formed on the table 12. The screen 14 may be in the form of a dedicated screen, or alternatively in the form of a separate thin-plate member such as a white sheet of paper.

That is to say, in the present embodiment, the top surface of the table 12 constitutes an example of the “support surface” set forth in the above mode (1), and the top surface of the screen 14 constitutes an example of the “projection surface” set forth in the same mode.

As illustrated in FIG. 1, the projector 10 includes a projection device 20 (e.g., projection unit) and a supporting device 22. The supporting device 22 is placed on the table 12 for use in supporting the projection device 20 over the table 12. The projection device 20 includes a hollow housing 30. The housing 30, when in use, is oriented so as to extend horizontally over the table 12. The housing 30 houses an assemblage optical system 32 and a control unit 34.

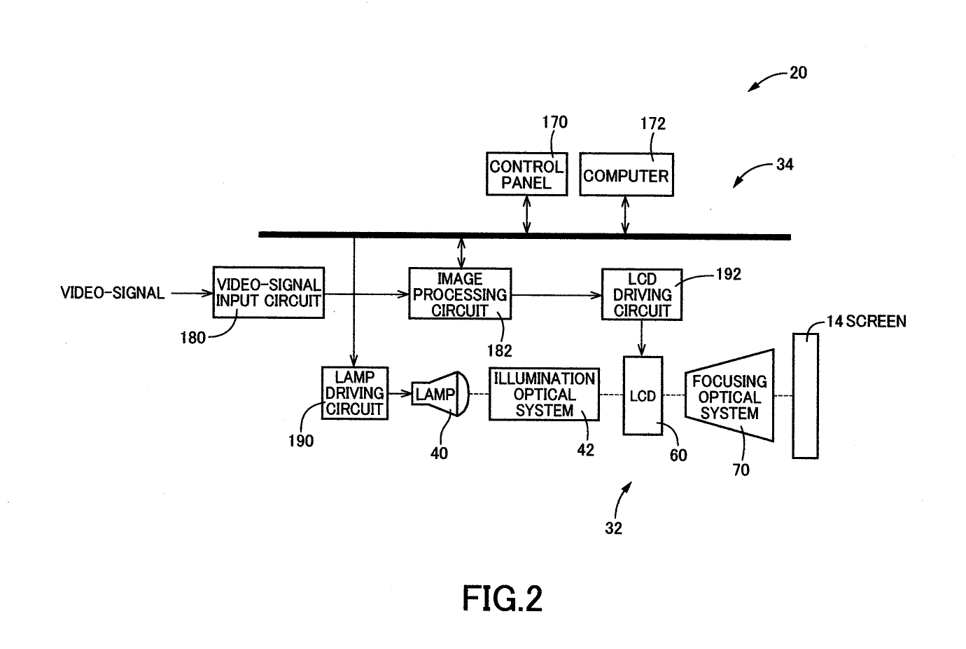

The assemblage optical system 32 is illustrated in FIG. 1 structurally, while the assemblage optical system 32 is illustrated in FIG. 2 schematically in block diagram. The assemblage optical system 32 includes a lamp 40 (an exemplary light source) such as an ultra-high pressure mercury lamp, and an illumination optical system 42. The illumination optical system 42 includes a condenser lens 44 adapted to collect light emitted from the lamp 40, and further includes a relay lens system 46 on an optical downstream side from the condenser lens 44. The condenser lens 44 and the relay lens system 46 are horizontally aligned together with the lamp 40.

The illumination optical system 42 further includes a mirror 50 on an optical downstream side from the relay lens system 46. The mirror 50 is adapted to allow light emerging from the relay lens system 46 to bend downwardly 90.degree.

As illustrated in FIGS. 1 and 2, the assemblage optical system 32 further includes a liquid crystal display (LCD) 60 (e.g., a transmissive LCD) on an optical downstream side from the illumination optical system 42. The LCD 60 receives light reflected from the mirror 50. The LCD 60 performs at least spatial modulation both of spatial modulation and temporal modulation of light incident on the LCD 60 from the illumination optical system 42, to thereby transform the incident light into imaging light representative of a display image.

The LCD 60 is no more than an example of an optical modulating element for use in transforming an electrical video signal into a visual image. Accordingly, the LCD 60 is not limited to a transmissive LCD but may be alternatively in the form of, for example, a reflective liquid crystal element typified by a liquid crystal on silicon (LCOS) or a mirror device referred to in the art as a deformable or digital micro-mirror device (DMD).

As illustrated in FIGS. 1 and 2, the assemblage optical system 32 further includes a focusing optical system 70 (e.g., image-forming or imaging optical system). The focusing optical system 70 is configured principally with a plurality of lenses. The focusing optical system 70 has an optical axis perpendicular to the screen 14, wherein the plurality of lenses of the focusing optical system 70 are vertically aligned along the optical axis. The focusing optical system 70 is adapted to project light coming from the LCD 60 onto the screen 14, to thereby focus a projected image onto the screen 14.

Within the housing 30, an aperture 74 is formed through which light emerging from the focusing optical system 70 passes. The aperture 74, however, is occluded by a last-stage lens 76 of the plurality of lenses of the focusing optical system 70.

As illustrated in FIG. 1, the supporting device 22 includes an extension/retraction mechanism 90 and a base 92. The extension/retraction mechanism 90 is configured such that a rod 94 is in fitting engagement with a cylinder 96 with the rod 94 being axially movable relative to the cylinder 96. The rod 94 and the cylinder 96 both extend parallel to an optical axis of light emerging from the last-stage lens 76, which is to say, perpendicular to the screen 14.

To an end portion 98 of the rod 94 which protrudes from the cylinder 96, the housing 30 of the projection device 20 is fixed. The cylinder 96 is fixed to the base 92 placed on the table 12. The extension/retraction mechanism 90 is adapted to vary a protrusion length of the rod 94, to thereby vary the height of the projection device 20 from the screen 14, which is to say, a projection or throw distance L between an exit face 106 of the projection device 20 and the screen 14.

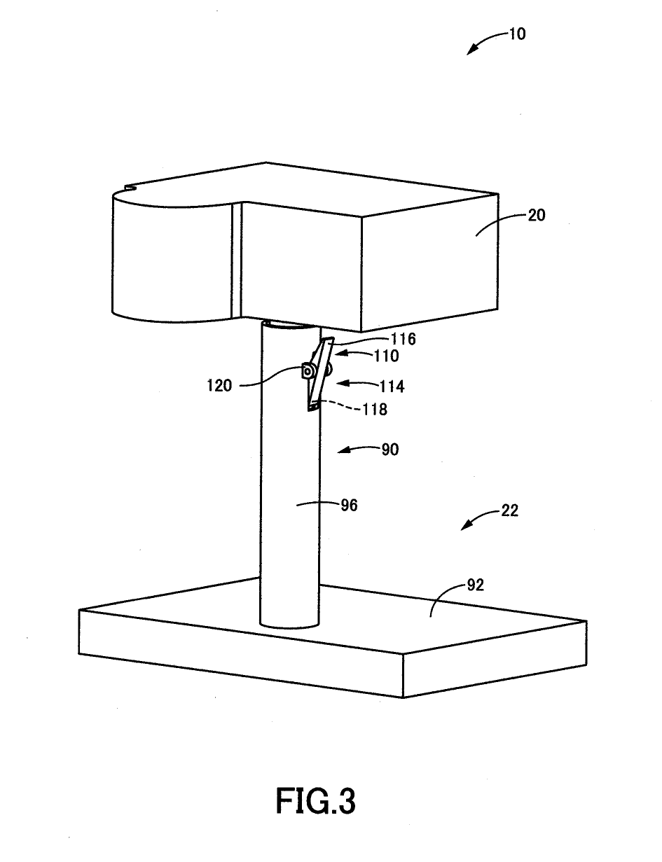

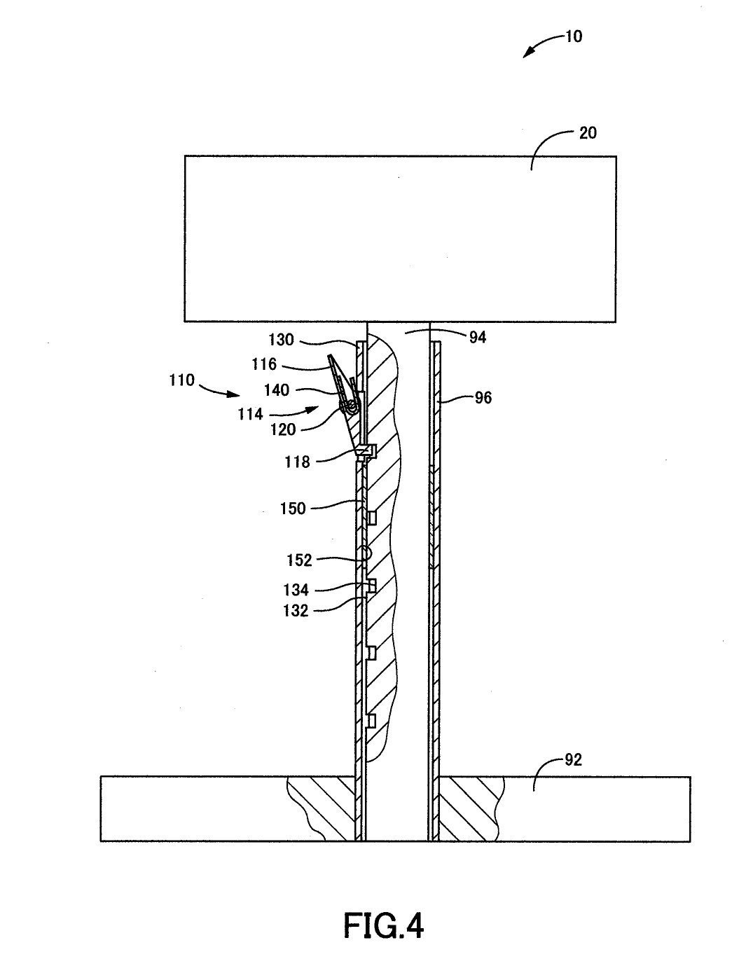

FIG. 3 illustrates in perspective view the projector 10 with the projection device 20 being in a lower-most position, and with the projection distance L therefore having a minimum value. FIG. 4 illustrates the projector 10 situated in the same position as that in FIG. 3, in partially sectional side view.

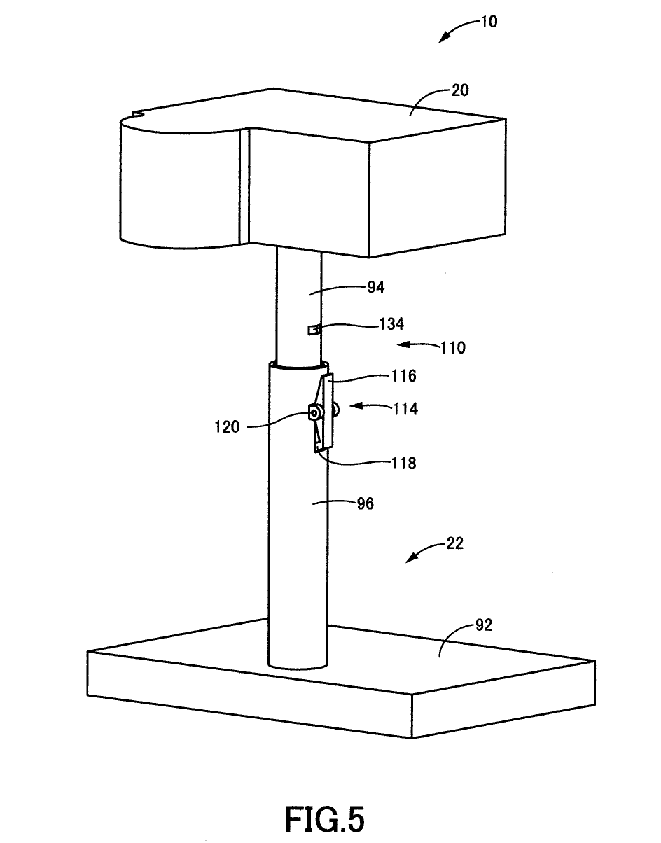

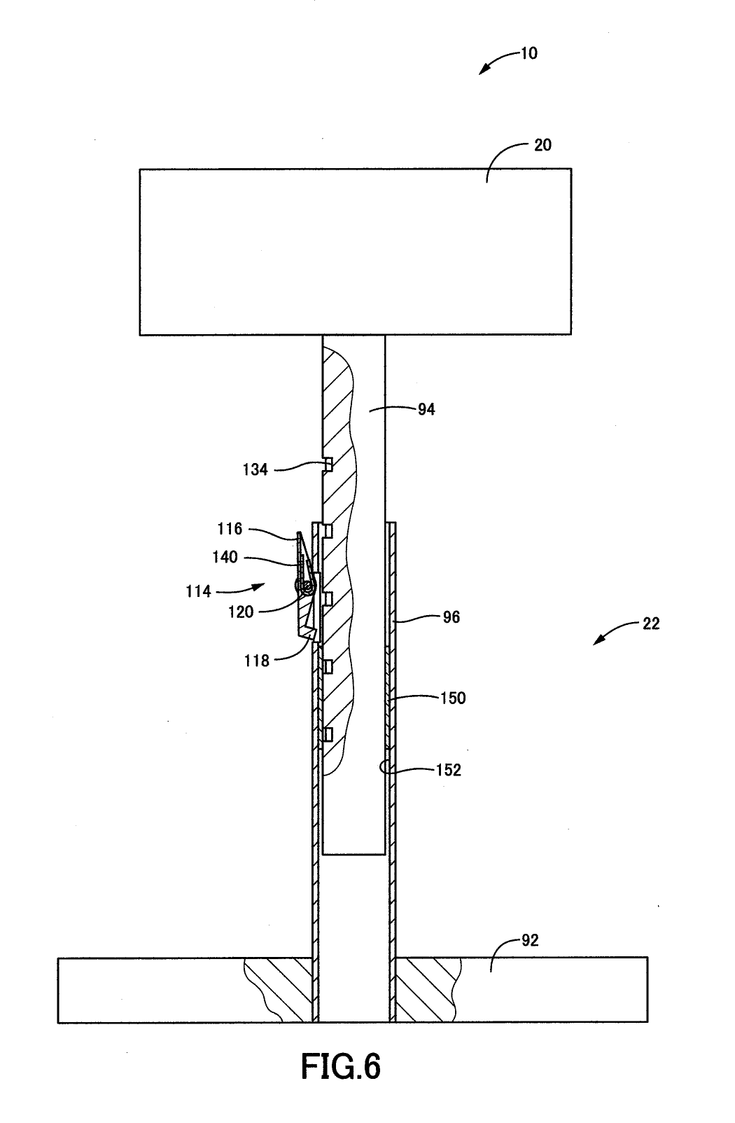

FIG. 5 illustrates in perspective view the projector 10 with the projection device 20 being in an intermediate position between the lower-most position and an upper-most position, and with the projection distance L therefore having an intermediate value between a lower limit value and an upper limit value. FIG. 6 illustrates the projector 10 situated in the same position as that in FIG. 5, in partially sectional side view.

The focusing optical system 70 has such deep depth-of-field, as its optical property, as to allow a projected image to be substantially maintained in viewer-acceptable focus over a full adjustable range of the projection distance L. The focusing optical system 70 is adapted to focus a projected image onto the screen 14 (i.e., the projection surface) using such an optical property.

More specifically, the focusing optical system 70 may be configured, for example, such that an f-number (=f/D, where “f”denotes a focal length of the lens and “D” denotes an effective diameter of the lens) has a value larger than normal, which value is, for example, within the range of approximately 4 to approximately 5, to thereby allow the focusing optical system 70 to have deeper depth-of-field than normal.

The focusing optical system 70, although different from that in a second illustrative embodiment of the prevent invention described later on, in that the focusing optical system 70 has no function of adjusting or altering the focus position of a projected image, allows a projected image to be kept in viewer-acceptable focus irrespective of changes in the projection distance L, owing to the deep depth-of-field.

As illustrated in FIGS. 3 and 4, the extension/retraction mechanism 90 includes a hand-operable locking mechanism 110. The locking mechanism 110 is adapted to allow selective fitting engagement and disengagement between a recessed portion and a projecting portion using a snap action.

In the present embodiment, the locking mechanism 110 includes a lock lever 114 which is actuated by a user and which is provided at its both ends with a user-operable part 116 and an engaging projection 118, respectively.

The locking mechanism 110 further includes a mount 120 for allowing the lock lever 114 to be mounted in the cylinder 96 (i.e., a stationary member) in a manner that the lock lever 114 is pivotable about an axis intersecting with respect to an axis of the rod 94.

The engaging projection 118 of the lock lever 114 penetrates through an outer circumferential wall 130 of the cylinder 96, in the face of an outer circumferential surface 132 of the rod 94. On the outer circumferential surface 132 of the rod 94, a plurality of recessed portions 134 are aligned along the axis of the rod 94. Each recessed portion 134 is shaped so that it can be brought into fitting engagement with the engaging projection 118 of the lock lever 114 without noticeable looseness.

The locking mechanism 110 further includes a biasing member 140 for biasing all the time the lock lever 114 in a direction allowing the engaging projection 118 of the lock lever 114 to become closer to the rod 94. In the example illustrated in FIG. 4, the biasing member 140 is in the form of a leaf spring.

Therefore, once a user has actuated the lock lever 114, the engaging projection 118 is disengaged from any one of the recessed portions 134, which brings the rod 94 into a state in which the rod 94 is telescopically movable relative to the cylinder 96. This state is an unlocked state in which the lock lever 114 is illustrated in FIGS. 5 and 6. In the unlocked state, the user can alter the height of the projection device 20, to thereby set the projection distance L to any desired value. That is to say, the user can enlarge or reduce a projected image.

Thereafter, once the user releases the lock lever 114 while holding the rod 94, the lock lever 114 elastically returns to a locked position in which the engaging projection 118 of the lock lever 114 is in fitting engagement with any one of the recessed portions 134. This is a locked state in which the lock lever 114 is illustrated in FIGS. 3 and 4.

In the locked state, the rod 94 and the projection device 20 are mechanically inhibited from being raised or lowered relative to the cylinder 96.

Further, in the locked state, the engaging projection 118 is in fitting engagement with any one of the recessed portions 134 without noticeable looseness not only in an axial direction of the rod 94 but also in a circumferential direction of the rod 94. As a result, the rod 94 and the projection device 20 are also mechanically inhibited from being pivoted relative to the cylinder 96.

As illustrated in FIG. 4, a sleeve 150 is inserted in between the rod 94 and the cylinder 96. The sleeve 150, which is made of a highly slick and slippery plastic material, such as Teflon (trademark), functions to eliminate or reduce the resistance to slide movement between the rod 94 and the cylinder 96. The sleeve 150 is fixed to an inner circumferential surface 152 of the cylinder 96 so as not to be axially moved as the rod 94 is raised or lowered.

As will be evident from the above explanation, in the present embodiment, the supporting device 22 is configured to be telescopic, thereby allowing a user to arbitrarily alter the projection distance L within the range of a lower limit value (e.g., 200 mm) to an upper limit value (e.g., 400 mm) in order to enlarge/reduce a projected image.

In the present embodiment, although the projection device 20 is configured with an optical system incapable of providing the projection device 20 with a zoom function, the projector 10 can entirely provide a zoom function owing to an extension/retraction function of the supporting device 22. The present embodiment, therefore, allows the projector 10 to have a zoom function without making an optical system within the projector 10 complicated in structure.

Although the projector 10 has been described above, such that the projection device 20 is described only with respect to the assemblage optical system 32, while the supporting device 22 is described entirely, then the projection device 20 will be described below in more detail with respect to a control unit 34 with reference to FIG. 2.

As illustrated in FIG. 2, the control unit 34 includes a control panel 170 and a computer 172. The control panel 170 is manipulated by a user to allow the computer 172 to capture a user's command. The computer 172 performs general control of the entire control unit 34 according to the user's command captured through the control panel 170.

The control unit 34 further includes a video-signal input circuit 180 and an image processing circuit 182. The control unit 34 is configured to allow a video signal as an image signal to enter the video-signal input circuit 180. The entered video signal is delivered to the image processing circuit 182. Information relating to the entered video signal is delivered to the computer 172.

The image processing circuit 182 is adapted to transform the video signal delivered from the video-signal input circuit 180, into a desirable drive signal for operating the LCD 60. The image processing circuit 182 is further adapted to perform signal processing for the video signal entered from the video-signal input circuit 180 to the image processing circuit 182, such that the video signal is processed for addition of a specific signal thereto, modification or the like, according to a command from the computer 172.

As a result, the image processing circuit 182 generates a video signal representative of a visual image to be projected, and delivers the generated video signal to an LCD driving circuit 192.

The control unit 34 further includes a lamp driving circuit 190 and the LCD driving circuit 192. The lamp driving circuit 190 is adapted to control the lamp 40 according to a command from the computer 172, to thereby selectively turn on/off the lamp 40.

Into the LCD driving circuit 192, there is entered from the image processing circuit 182 a video signal which has been subjected to the aforementioned signal processing. Based on the entered video signal, the LCD driving circuit 192 generates a desirable drive signal for operating the LCD 60, and supplies the generated drive signal to the LCD 60 for operation of the LCD 60. As a result, imaging light is generated which is indicative of the video signal entered into the video-signal input circuit 180.

The present embodiment, therefore, allows projection on the screen 14 of the imaging light representative of a visual image indicated by a video signal entered into the projector 10, to thereby display a projected image on the screen 14.

As will be evident from the above explanation, in the present embodiment, the extension/retraction mechanism 90, the base 92 and the locking mechanism 110 together constitute the supporting device 22, the supporting device 22 constitutes an example of the “supporting device” set forth in the above mode (1), and the focusing optical system 70 constitutes an example of the “focusing optical system”set forth in the above mode (2).

### SECOND ILLUSTRATIVE EMBODIMENT

Next, a second illustrative embodiment of the present invention will be described.

The common elements of the present embodiment to those of the first embodiment, however, will be referenced the same reference numerals or names as those of the first embodiment, without redundant description or illustration, while only the distinctive elements of the present embodiment from those of the first embodiment will be described below in detail.

The projector 10 constructed according to the first embodiment as depicted in FIG. 1 is configured such that the projection device 20 is unpivotably coupled to the supporting device 22 about a horizontal axis, and such that the supporting device 22 includes one leg which extends vertically and generally rectilinearly.

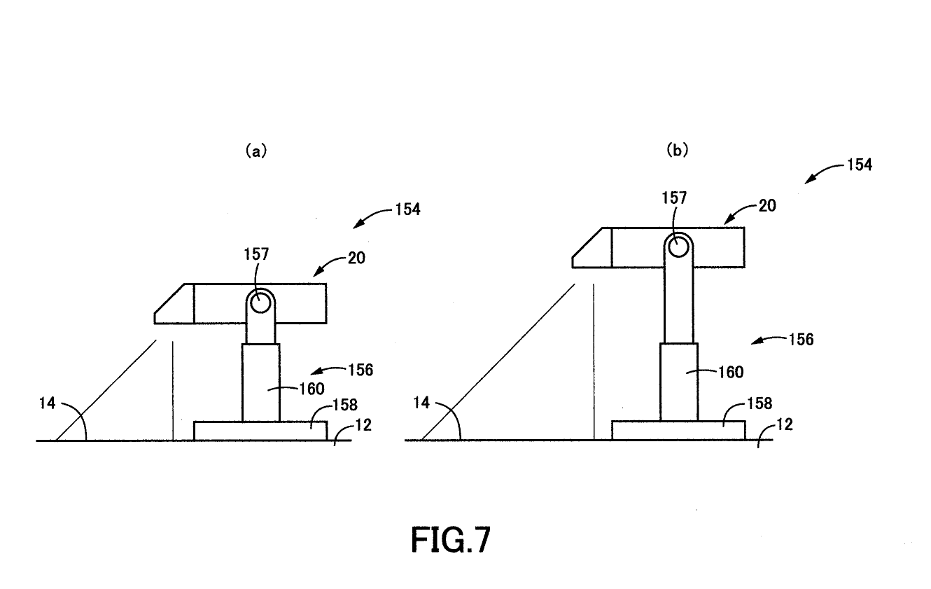

FIG. 7(a) illustrates in side view a projector 154 constructed according to the present embodiment in a minimum magnification position in which the projection distance L takes a minimum value and therefore an image is projected with a minimum magnification scale.

In contrast, FIG. 7(b) illustrates in side view the projector 154 in a maximum magnification position in which the projection distance L takes a maximum value and therefore an image is projected with a maximum magnification scale.

The projector 154 constructed according to the present embodiment, differently from the projector 10 depicted in FIG. 1, is configured such that the projection device 20 is pivotably coupled to a supporting device 156 about a horizontal axis, and such that the supporting device 156 includes a pair of joints 157 and 157 pivotably coupled to the projection device 20.

In the present embodiment, the pair of joints 157 and 157 are pivotably coupled to both side faces of the projection device 20, respectively, about an axis extending horizontally and passing through the projection device 20. This allows a projection surface of the projector 154 to be defined as the same surface as the support surface on which the projector 154 is placed, or as a different surface (e.g., a ceiling which is an exemplary down-facing surface) from the support surface.

Further, in the present embodiment, the supporting device 156 further includes a base 158 placed on a table 12, and a leg 160 for coupling the base 158 to the pair of joints 157 and 157.

The leg 160 may be configured to include a single straight trunk portion which extends upwardly from the base 158 to near and before the projection device 20, and two straight branched portions which coextend upwardly to the pair of joints 157 and 157 from an upper end of the trunk portion which is located close to the projection device 20.

Alternatively, the leg 160 may be configured to have two straight portions which coextend in parallel and upwardly from the base 158 to the pair of joints 157 and 157.

In any case, the leg 160 is configured to couple the base 158 to the pair of joints 157 and 157 so as to create a clearance large enough to allow the projection device 20 to pass therethrough for pivotal movement of the projection device 20 about a horizontal axis.

### THIRD ILLUSTRATIVE EMBODIMENT

Next, a third illustrative embodiment of the present invention will be described.

The common elements of the present embodiment to those of the second embodiment, however, will be referenced the same reference numerals or names as those of the first embodiment, without redundant description or illustration, while only the distinctive elements of the present embodiment from those of the second embodiment will be described below in detail.

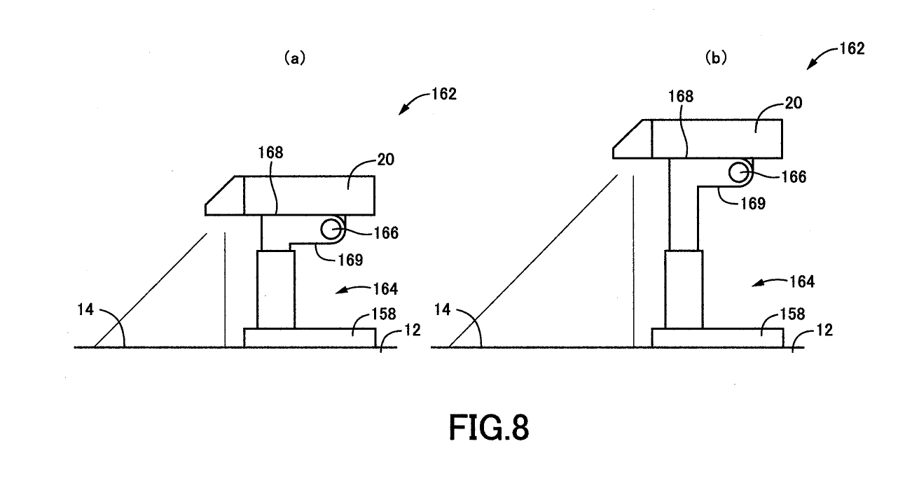

FIG. 8(a) illustrates in side view a projector 162 constructed according to the present embodiment in a minimum magnification position in which the projection distance L takes a minimum value and therefore an image is projected with a minimum magnification scale.

In contrast, FIG. 8(b) illustrates in side view the projector 162 in a maximum magnification position in which the projection distance L takes a maximum value and therefore an image is projected with a maximum magnification scale.

The projector 162, similarly with the projector 154 constructed according to the second embodiment as depicted in FIG. 7, is configured such that a projection device 20 is pivotably coupled to a supporting device 164 about a horizontal axis. The supporting device 164, differently from the supporting device 156 of the projector 154 depicted in FIG. 7, includes a single joint 166 pivotably coupled to the projection device 20 about a horizontal axis extending under the projection device 20.

The joint 166 is configured to have a horizontal surface with which a bottom surface of the projection device 20 is in contact when the projection device 20 is in a normal position as illustrated in FIGS. 8(a) and 8(b). The horizontal surface acts as a first defining surface 168 which defines one of both extreme positions of pivotal movement of the projection device 20. In the normal position, the projection device 20 projects imaging light vertically and downwardly.

The joint 166 has an additional horizontal surface with which the bottom surface of the projection device 20 is in contact when the projection device 20 is in an inverted position (not shown). The additional horizontal surface acts as a second defining surface 169 which defines the other of both extreme positions of pivotal movement of the projection device 20.

The inverted position corresponds to a position that the projection device 20 is rotated clockwise from the normal position by 180.degree. In the inverted position, the projection device 20 projects imaging light vertically and upwardly.

The present embodiment, therefore, allows the projection device 20 to be in contact with a selected one of the first defining surface 168 and the second defining surface 169, which makes it easier to angularly locate the projection device 20 at a corresponding one of the normal position and the inverted position within a vertical plane of the projection device 20, with improved accuracy.

Further, the present embodiment allows the projection direction of the projection device 20 to be altered without changing the support position of the projector 162, which provides greater flexibility in the selection of a projection surface, and which enables the projection distance to be adjusted for any projection surface that has been selected.

Still further, the present embodiment allows the projector 162 to project imaging light onto a projection surface perpendicular to the support surface of the projector 162, and also allows the imaging light to be adjusted in position within the projection surface. That is to say, the present embodiment allows a projection height of the imaging light to be adjusted relative to the vertical projection surface.

### FOURTH ILLUSTRATIVE EMBODIMENT

Next, a fourth illustrative embodiment of the present invention will be described below.

The present embodiment is different from the first embodiment in that the present embodiment is configured to incorporate additional elements for providing an automatic focusing function, although in common to the first embodiment with respect to the remaining elements.

The common elements of the present embodiment to those of the first embodiment, therefore, will be referenced the same reference numerals or names as those of the first embodiment, without redundant description or illustration, while only the distinctive elements of the present embodiment from those of the first embodiment will be described below in detail.

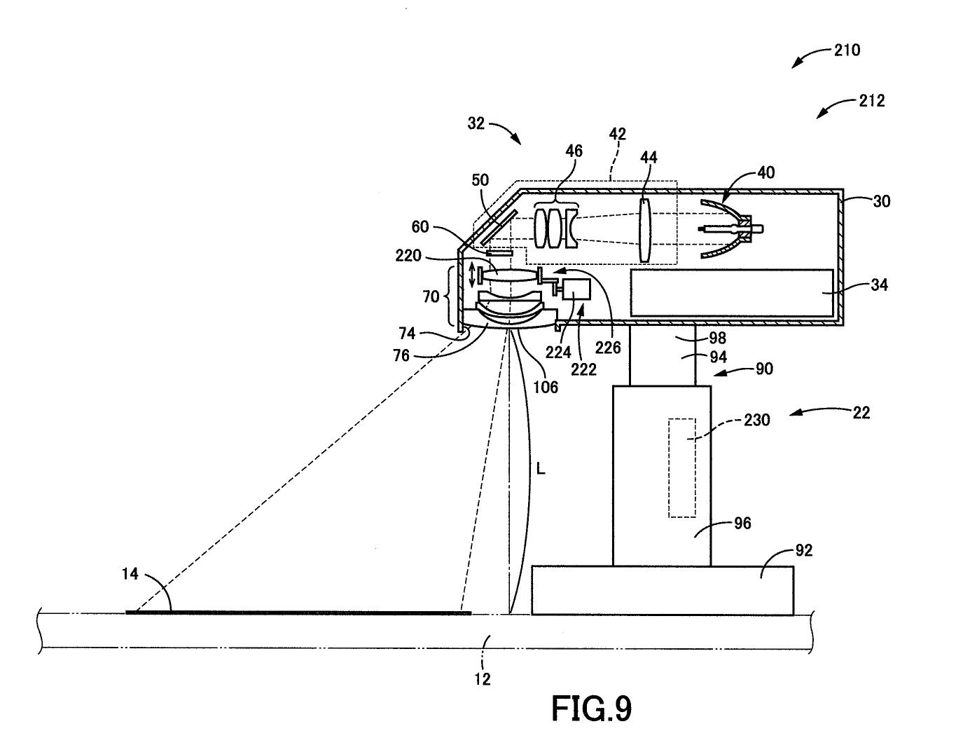

As illustrated in FIG. 9, a projector 210 constructed according to the present embodiment includes a projection device 212 and a supporting device 22. The projection device 212 is different from the projection device 20 depicted in FIG. 1 in that a focusing optical system 70 of the projection device 212 includes a focusing function (focus position control).

More specifically, one of a plurality of lenses of the focusing optical system 70 is in the form of a movable lens 220. The movable lens 220 is configured to be movable along its optical axis, and the position of the movable lens 220 is changed by means of a focusing mechanism 222.

As illustrated in FIG. 9, the focusing mechanism 222 is configured to include a motor 224 and a motion converting mechanism 226 (e.g., a screw mechanism) for converting the rotational motion of the motor 224 into the rectilinear motion of the movable lens 220. This allows electrical control of the focus position of the projected image formed on a screen 14 using light emerging from the focusing optical system 70.

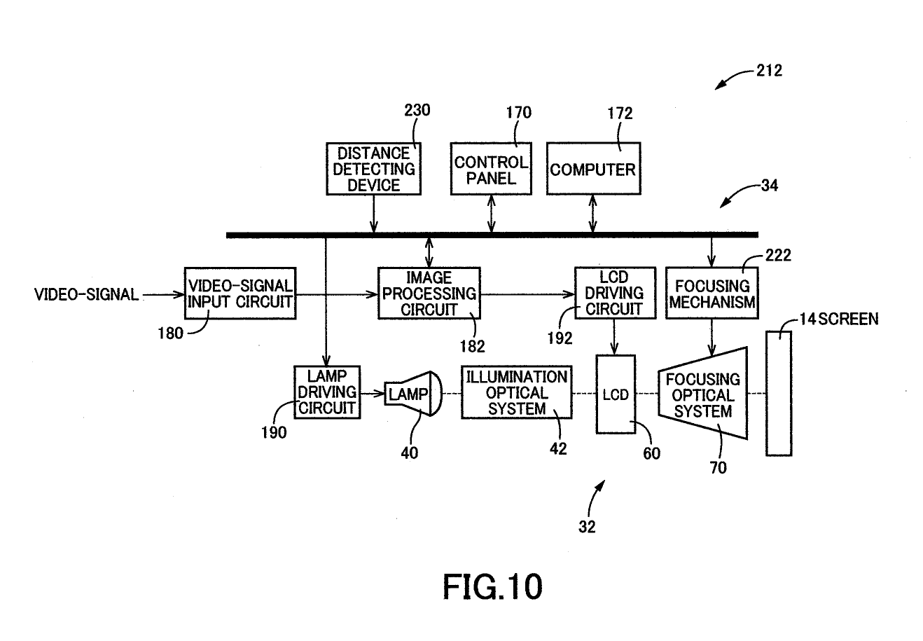

As illustrated in FIG. 10, a control unit 34 further includes a distance detecting device 230. The distance detecting device 230 is provided to detect a projection distance L between an optical exit face of the projection device 20 and the screen 14 (i.e., the projection surface). The distance detecting device 230 may be of a non-contact-type (e.g., optical, magnetic types, etc.) or a contact-type (e.g., an electrical switch type, etc.). The distance detecting device 230 may be configured to detect the projection distance L step-wise or continuously.

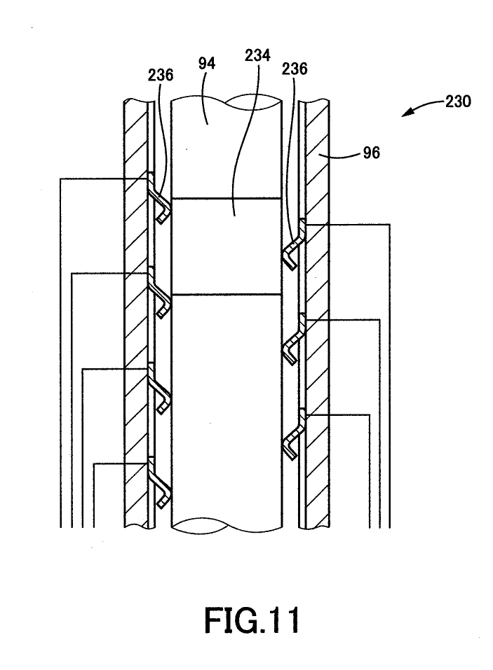

In the present embodiment, the distance detecting device 230 is of a contact type. More specifically, as illustrated in FIG. 11 in sectional side view, the distance detecting device 230 is configured to include a movable conductive element 234 (e.g., a conductive band) fixedly which is attached to an outer circumferential surface of a rod 94 for integral movement therewith, and a plurality of fixed contacts 236 (e.g., conductive elastic pieces) axially aligned at separate locations on an inner circumferential surface of a cylinder 96.

That is to say, the movable conductive element 234 moves together with the rod 94 acting as a movable member, while the plurality of fixed contacts 236 are fixed to the cylinder 96 acting as a stationary member. The fixed contacts 236 are elastically pressed against an outer circumferential surface 132 of the rod 94 all the time.

As illustrated in FIG. 11, the fixed contacts 236 are grouped into first and second groups. Both a first sub-plurality of the fixed contacts 236 which belong to the first group depicted on the left-hand side in FIG. 11 and a second sub-plurality of the fixed contacts 236 which belong to the second group depicted on the right-hand side in the same figure are disposed along an axial direction of the cylinder 96.

The first sub-plurality of fixed contacts 236 belonging to the first group (depicted on the left-hand side in FIG. 11) elastically forces the rod 94 radially inwardly. To cancel the force for smooth elevation of the rod 94, the second sub-plurality of fixed contacts 236 belonging to the second group (depicted on the right-hand side in FIG. 11) are opposed to the first sub-plurality of fixed contacts 236 belonging to the first group with the rod 94 being interposed therebetween.

In the distance detecting device 230, the movable conductive element 234 is configured to have such a long dimension in a longitudinal direction of the rod 94, which is to say, a width of the movable conductive element 234 that there exist two of all the fixed contacts 236, which is to say, any one of the fixed contacts 236 of the first group and any one of the fixed contacts 236 of the second group are electrically connected with each other, in any and every axial position of the rod 94.

In the distance detecting device 230, additionally, one of the fixed contacts 236 of the first group and one of the fixed contacts 236 of the second group which correspond to each other are disposed so as to be deviated from each other with respect to the axial positions aligned along the rod 94 (i.e., the phases assigned in the axial direction of the rod 94), by one-half the pitch (i.e., the interval) of adjacent two of the fixed contacts 236 belonging to the same group.

In the thus-constructed distance detecting device 230, for detecting the projection distance L, there are identified two of all the fixed contacts 236 which are electrically connected with each other via the movable conductive element 234. Based on the identified two fixed contacts 236, the current position of the movable conductive element 234 and the current axial position of the rod 94 are detected and eventually the projection distance L is detected.

Thus, in the distance detecting device 230, there exist two of all the fixed contacts 236 which are electrically connected with each other, in any and every axial position of the rod 94, resulting in the absence of any time period for which the projection distance L cannot be detected during axial movement of the rod 94. As a result, the distance detecting device 230 can detect the projection distance L with high resolution for the total number of the fixed contacts 236.

It is, however, in essential to configure the distance detecting device 230 in a manner described above in practicing the present invention.

The present invention may be practiced in an alternative arrangement, for example, in which a time period during which two fixed contacts 236 electrically connected are present, and a time period during which such two fixed contacts 236 are not present occur alternately as the rod 94 moves in one of both directions (e.g., an arrangement in which any one of the fixed contacts 236 belonging to the first group and any one of the fixed contacts 236 belonging to the second group, which are paired with each other, are disposed without being deviated from each other in a longitudinal direction of the rod 94).

In this alternative arrangement, during the period in which a current pair of two fixed contacts 236 electrically connected are not present, the detection value of the projection distance L may be held equal to the previous value of the projection distance L which was detected based on the position of an immediately previous pair of two fixed contacts 236 which were electrically connected immediately before.

In this alternative arrangement, when the rod 96 can be fixedly held only at any one of a plurality of discrete axial locations (no intermediate stop position), it is enough that two fixed contacts 236 which can be electrically connected with each other are provided only at those discrete axial locations, respectively.

For detecting the projection distance L using the distance detecting device 230 as described above, a computer 172 executes a distance detection program (not shown).

The computer 172 further executes an automatic focusing program, based on the projection distance L detected by means of the distance detecting device 230, to thereby automatically prevent a projected image from becoming blurry due to adjustment of the projection distance L by a user.

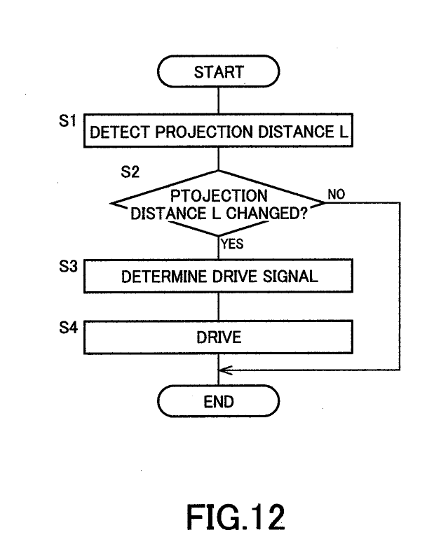

In FIG. 12, the automatic focusing program is conceptually illustrated in flow chart. This automatic focusing program is repeatedly executed by the computer 172.

Each cycle of execution of this automatic focusing program begins with step Si to detect the projection distance L based on an output signal from the distance detecting device 230.

Thereafter, at step S2, it is determined whether or not the currently detected value of the projection distance L has changed from the previously detected value by an amount not less than a predetermined value. In other words, it is determined whether or not a user has adjusted the height of the projection device 212.

If there is no change of the currently detected value of the projection distance L from the previously detected value by an amount not less than the predetermined value, then the determination of step S2 becomes “NO.” Then, one cycle of execution of this automatic focusing program is immediately terminated.

In contrast, if there is a change of the currently detected value of the projection distance L from the previously detected value by an amount not less than the predetermined value, then the determination of S2 becomes “YES.”

Then, this program proceeds to step S3 to determine a drive signal to be delivered to the focusing mechanism 222, based on the currently detected value of the projection distance L. The computer 172 has stored in its ROM (Read Only Memory) a predetermined relationship between the projection distances L and the drive signals. Based on the relationship, a drive signal corresponding to the currently detected value of the projection distance L is determined.

Subsequently, at step S4, the determined drive signal is delivered to the focusing mechanism 222. As a result, the movable lens 220 is moved by a desired amount by means of the focusing mechanism 222, to thereby adjust the focus position of a currently projected image. Then, one cycle of execution of this automatic focusing program is terminated.

As will be evident from the above explanation, in the present embodiment, the focusing mechanism 222 constitutes an example of the “focus adjuster” set forth in the above mode (3), and the distance detecting device 230 and a portion of the computer 172 which is assigned to execute the automatic focusing program depicted in FIG. 12 together constitute an example of the “controller” set forth in the same mode.

Further, in the present embodiment, the focusing mechanism 222 constitutes an example of the “focus adjuster” set forth in the above mode (4), and the distance detecting device 230 and a portion of the computer 172 which is assigned to execute the automatic focusing program depicted in FIG. 12 together constitute an example of the “controller” set forth in the same mode.

### FIFTH ILLUSTRATIVE EMBODIMENT

Next, a fifth illustrative embodiment of the present invention will be described below.

The present embodiment is common to the first embodiment with respect to many elements. Therefore, only the different elements of the present embodiment from those of the first embodiment will be described below in greater detail, while the common elements of the present embodiment to those of the first embodiment will be referenced the same reference numerals or names as those of the first embodiment, without redundant description or illustration.

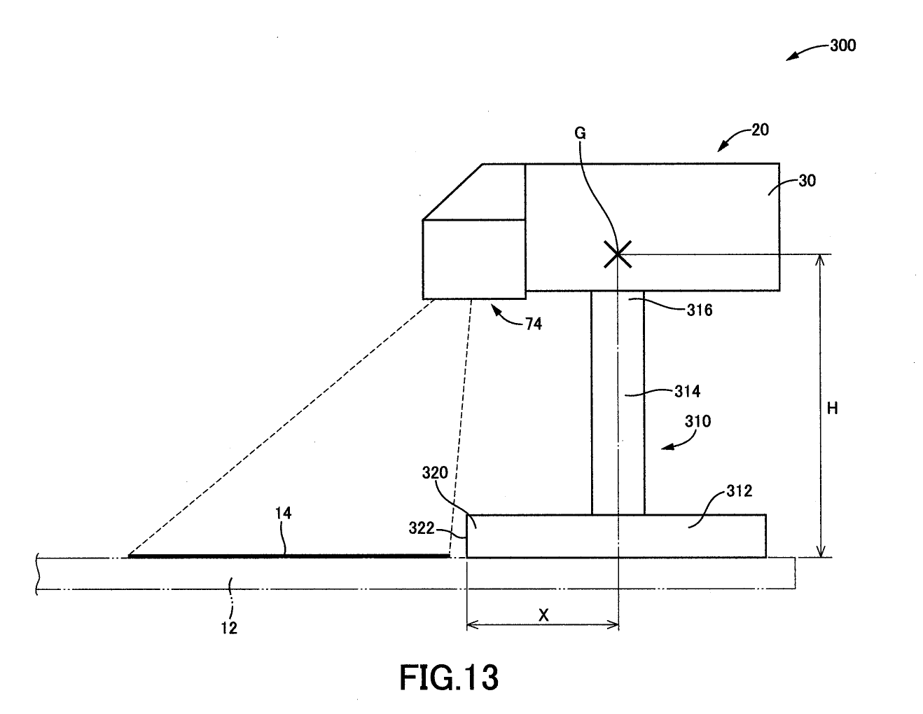

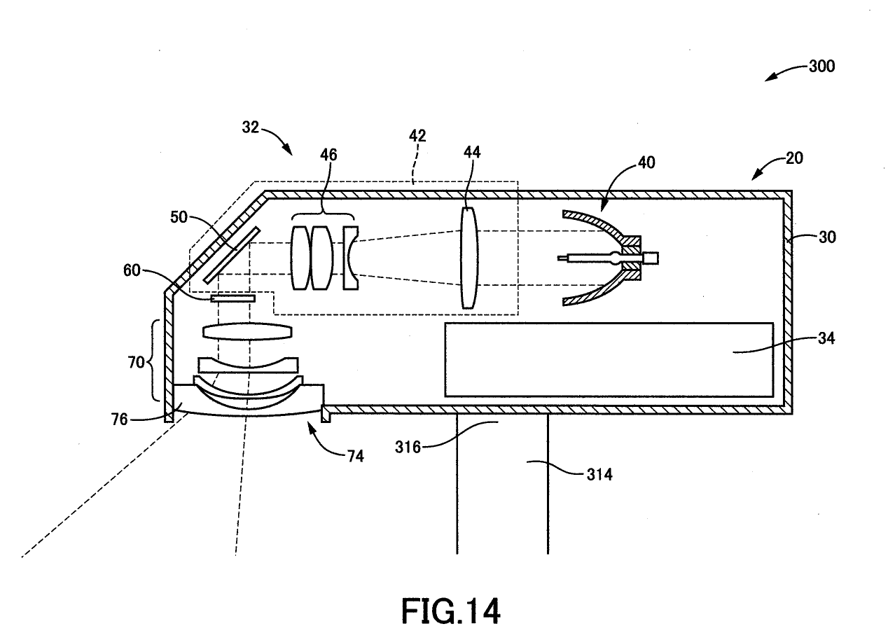

In FIG. 13, there is illustrated in side view a tabletop projector 300 constructed according to the fifth illustrative embodiment of the present invention. The projector 300 includes a projection device 20 as depicted in FIGS. 1 and 14, and a supporting device 310. The projection device 20 is held in a suspended position above an end portion of the top surface of a table 12 (i.e., a portion proximate to an edge of the table 12), by way of the supporting device 310.

As illustrated in FIG. 14, the projection device 20 has a horizontal optical axis along which the projection device 20 is oriented. A portion of the projection device 20 from which imaging light for displaying an image is emitted will be referred to as a front-side portion, while a portion of the projection device 20 from which such imaging light is not emitted will be referred to as a rear-side portion.

For the definitions of directions found in FIG. 13, a direction from the right-side to the left-side of the same figure corresponds to a forward direction of the projection device 20, while a direction from the left-side to the right-side of the same figure corresponds to a rearward direction of the projection device 20. In addition, a direction from the far side to the near side in the same figure corresponds to a leftward direction of the projection device 20, while a direction from the near side to the far side in the same figure corresponds to a rightward direction of the projection device 20.

As illustrated in FIG. 14, the projection device 20 includes a housing 30. The housing 30 houses a control unit 34, a lamp 40, an illumination optical system 42, an LCD 60 (e.g., a transmissive LCD panel) and a focusing optical system 70.

The lamp 40 and the illumination optical system 42 are aligned in series along the aforementioned horizontal optical axis. The focusing optical system 70 includes a last-stage lens (a projection lens) 76 which is disposed so as to be exposed at an aperture 74 of the housing 30. The aperture 74 is formed in the housing 30 so as to be open and face downwardly.

As illustrated in FIG. 13, in the present embodiment, the control unit 34, the lamp 40, the illumination optical system 42, the LCD 60 and the focusing optical system 70 are disposed in the housing 30, such that the center of gravity G of the projection device 20 is centrally located when viewed in a front-to-rear direction of the projection device 20.

The lamp 40 is electrically powered to emit light under the control of the control unit 34, to thereby throw light onto the illumination optical system 42. The illumination optical system 42 is adapted to cause light incoming from the lamp 40 to enter the LCD 60 as illumination light.

Under the control of the control unit 34, the LCD 60 is arranged to modulate illumination light incoming from the illumination optical system 42, according to an image signal delivered from the control unit 34, and cause the modulated illumination light to enter the focusing optical system 70 as imaging light.

As illustrated in FIG. 14, an optical axis of the focusing optical system 70 (i.e., a normal line passing through the center of the last-stage lens 76, although not shown) is disposed so as to be located rearwardly of an optical axis of outgoing light from a mirror 50 (i.e., a line passing through the center of the mirror 50, although not shown).

As a result of this arrangement, the focusing optical system 70 allows light incoming from the LCD 60 to pass through the last-stage lens 76 only in a front-side one of two halves of the last-stage lens 76 (a left-hand side one of the two halves, when viewed in FIG. 14). Light outgoing from the last-stage lens 76 is located in a region which is located forwardly of the optical axis of the last-stage lens 76.

The light outgoing from the last-stage lens 76 is projected onto a screen 14 on the table 12 through the aperture 74 of the housing 30. The outgoing light from the last-stage lens 76 allows an image which is displayed by means of the LCD 60, to be projected onto the screen 14 as a projected image.

In the present embodiment, imaging light representative of a display image is obliquely projected onto the screen 14, to thereby project the display image onto the screen 14.

As illustrated in FIG. 13, the supporting device 310 includes a plate-shaped base 312 and a strut 314. The base 312 is placed on an end portion of the table 12. The strut 314 extends out vertically upwardly from a center portion of the base 312. The strut 314 is fixedly secured at its free end portion 316 to the housing 30.

The positional relationship between the base 312 and the strut 314 has been established so that an image which is projected onto the screen 14 from the projection device 20 can be located as close as possible to a front-side end portion 320 of both end portions of the base 312 without spatial overlap with the front-side end portion 320. The both end portions of the base 312 are spaced apart in a front-to-rear direction of the base 312 depicted in FIG. 13 (i.e., a longitudinal direction of the projection device 20).

In this regard, the front-side end portion 320 is one of the both end portions of the base 312 which is proximate to the aperture 74 (i.e., an exit opening which imaging light for producing a projected image exits) of the projection device 20.

The positional relationship between the base 312 and the strut 314 may be established, for example, so that an edge of the projected image can be at least partially in contact with a front end face 322 of the front-side end portion 320, or alternatively so that a clearance not larger than 1 cm can be left between the edge of the projected image and the front end face 322 of the front-side end portion 320.

The positional relationship between the base 312 and the strut 314 is defined by both a distance X of the center of gravity G of the projection device 20 from the front end face 322 of the front-side end portion 320 of the base 312, which distance X is measured in a front-to-rear direction (a horizontal direction), and a height H of the center of gravity G of the projection device 20 from the top surface of the table 12.

In the present embodiment, the distance X and the height H are set so that the edge of the projected image can be located as close as possible to the front-side end portion 320, to thereby establish the positional relationship between the base 312 and the strut 314.

In the present embodiment, the configuration described above allows a projected image, upon activation of the projector 300, to be projected, by means of the projection device 20, onto the screen 14 through the aperture 74 of the housing 30.

As described above, the positional relationship between the base 312 and the strut 314 has been established so that the edge of the projected image can be located as close as possible to the front-side end portion 320 of the base 312. Therefore, a projected image is projected onto an area at a position which is located as close as possible to the front-side end portion 320 of the base 312 without spatial overlap therewith.

That is to say, in the present embodiment, an area occupied by a projected image and an area occupied by the base 312 are disposed on the table 12 so as to be closely spaced from each other.

Therefore, the present embodiment makes it easier to reduce the size of an area occupied by both the base 312 of the projector 300 and a projected image located on the table 12. As a result, it suffices for a viewer to ensure a space on the table 12 which is smaller in size than that required in the case of the conventional projectors, for enabling a projected image to be viewed with the same size.

Further, in the present embodiment, because it suffices for a viewer to ensure a space on the table 12 which is smaller in size than that required in the case of the conventional projectors, for enabling a projected image to be viewed with the same size, the viewer is allowed to use the table 12 having a size smaller than that required in the case of the conventional projectors, for enabling a projected image to be viewed with the same size.

Still further, in the present embodiment, the positional relationship between the projection device 20 and the supporting device 310 is established so that the center of gravity G of the projection device 20 can be located directly over the strut 314 of the supporting device 310. As a result, when viewed in plan view and side view, the center of gravity G of the projection device 20 lies on a center line of the strut 314, and the center of gravity G of the projection device 20 coincides with the center of gravity of the base 312. In the present embodiment, the projection device 20 is supported by the strut 314 at its free end portion 316.

Therefore, in the present embodiment, a counter moment can occur at the projector 300 due to the gravity of the projector 300 in a direction (a clockwise direction in FIG. 13) allowing the counter moment to cancel a possible moment occurring in a direction (a counterclockwise direction in FIG. 13) causing the projection device 20 to pivot forwardly about the front-side end portion 320.

The present embodiment, therefore, allows the projection device 20 to be held within a space over the table 12 by means of the supporting device 310 in a dynamically stabilized fashion. As a result, the projector 300 is prevented from unexpectedly tipping forward.

Yet further, in the present embodiment, the projection device 20 is supported by the strut 314 so as to allow the center of gravity G of the projection device 20 to be located directly over the strut 314. Therefore, a bending moment acting on the strut 314 due to a force imparted to the projection device 20 is reduced relative to that when the center of gravity G of the projection device 20 is deviated from the strut 314 in a front-to-rear direction of the projection device 20.

Accordingly, in the present embodiment, a reduction is achieved in the rigidity and the strength (e.g., the moment resistance) required for the supporting device 310 to support the projection device 20.

Therefore, in the present embodiment, the requirements for the rigidity and the strength of the supporting device 310 are relaxed, resulting in the facilitated reduction in manufacturing cost of the supporting device 310 and the increased flexibility in designing the exterior configuration of the supporting device 310.

It is added that, although an extension/retraction mechanism of the strut 314 is not illustrated in FIG. 13, the strut 314 may be configured to be telescopic, for example, by incorporation of an extension/retraction mechanism equivalent to the extension/retraction mechanism 90 depicted in FIG. 1, thereby allowing the projection device 20 to be adjustable in height.

### SIXTH ILLUSTRATIVE EMBODIMENT

Next, a sixth illustrative embodiment of the present invention will be described below.

The present embodiment is common to the fifth embodiment with respect to many elements, and is different from the fifth embodiment only with respect to elements concerning a supporting device to support a projection device in a projector.

Therefore, only the different elements of the present embodiment from those of the fifth embodiment will be described below in greater detail, while the common elements of the present embodiment to those of the fifth embodiment will be referenced the same reference numerals or names as those of the fifth embodiment, without redundant description or illustration.

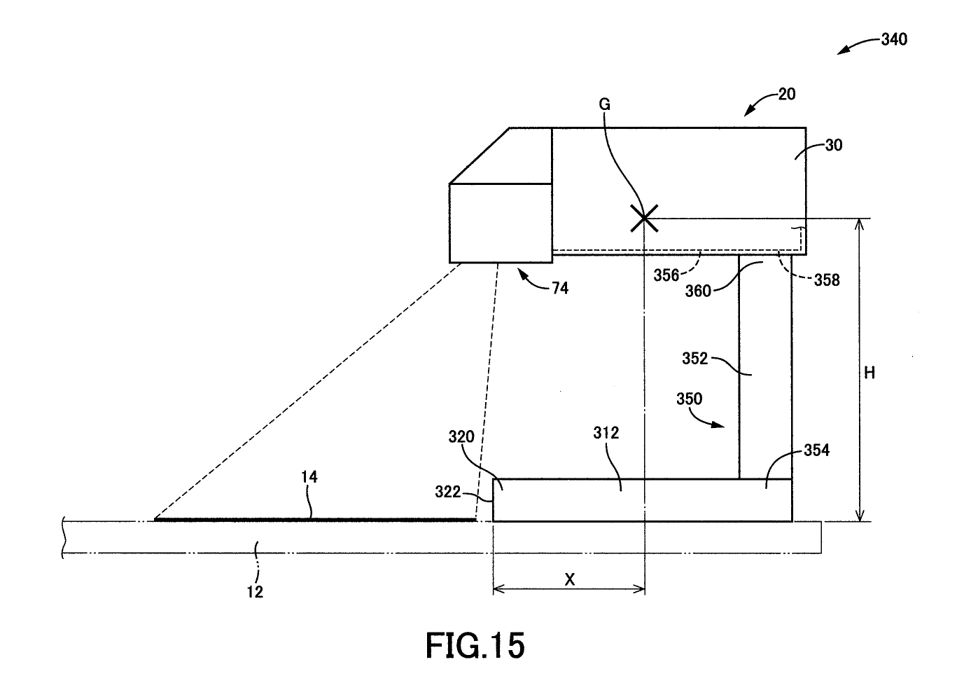

In FIG. 15, there is illustrated in side view a tabletop projector 340 constructed according to the present embodiment. The projector 340 includes a projection device 20 as depicted in FIG. 13, and a supporting device 350 placed on a table 12 to support the projection device 20 in a suspended position over the table 12.

As illustrated in FIG. 15, the supporting device 350 includes a base 312 as depicted in FIG. 13, and a strut 352. The strut 352, differently from the strut 314 depicted in FIG. 13, extends out vertically upwardly from a rear-side end portion 354 of the base 312.

As illustrated in FIG. 15, in the present embodiment, the projection device 20 is supported at a rear end portion 358 of a bottom wall 356 of a housing 30, by means of a free end portion 360 of the strut 352. As a result, the strut 352 is located rearward (rightward in FIG. 15) with respect to the center of gravity G of the projection device 20.

In the present embodiment, however, similarly with the fifth embodiment, the center of gravity G of the projection device 20 coincides with the center of gravity of the base 312, when viewed in plan view.

In the present embodiment, the strut 352, as described above, extends out vertically upwardly from the rear-side end portion 354 of the base 312, with the result that the strut 352 is located rearward with respect to the center of gravity G of the projection device 20. As a result, the center of gravity (not shown) of the entire projector 340 including the strut 352 is located rearward with respect to the center of gravity of the entire projector 300 of the fifth embodiment, both when viewed in plan view and side view.

Therefore, in the present embodiment, similarly with the fifth embodiment, a counter moment occurs at the projector 340 due to the gravity of this projector 340, in a direction allowing the counter moment to cancel a tipping moment causing the projection device 20 to tip forward about the front end face 322 of the front-side end portion 320. The counter moment occurring in a direction to cancel the tipping moment is larger than that caused in the fifth embodiment by an amount commensurate with an amount by which the center of gravity of the projector 340 is located rearward with respect to the center of gravity of the projector 300 constructed according to the fifth embodiment.

Accordingly, the present embodiment allows the projector 340 to be placed on the table 12 in a dynamically stabilized fashion. As a result, the present embodiment, similarly with the fifth embodiment, prevents the projector 340 from unexpectedly tipping forward.

In the present embodiment, the positional relationship between the projection device 20 and the base 312 is common to that of the fifth embodiment. Therefore, similarly with the fifth embodiment, a projected image projected by the projection device 20 onto the screen 14 is located as close as possible to the front-side portion 320 of the base 312 without any overlap therewith.

### SEVENTH ILLUSTRATIVE EMBODIMENT

Next, a seventh illustrative embodiment of the present invention will be described below.

The present embodiment is common to the fifth embodiment with respect to many elements, and is different from the fifth embodiment only with respect to elements concerning a supporting device to support a projection device in a projector.

Therefore, only the different elements of the present embodiment from those of the fifth embodiment will be described below in greater detail, while the common elements of the present embodiment to those of the fifth embodiment will be referenced the same reference numerals or names as those of the fifth embodiment, without redundant description or illustration.

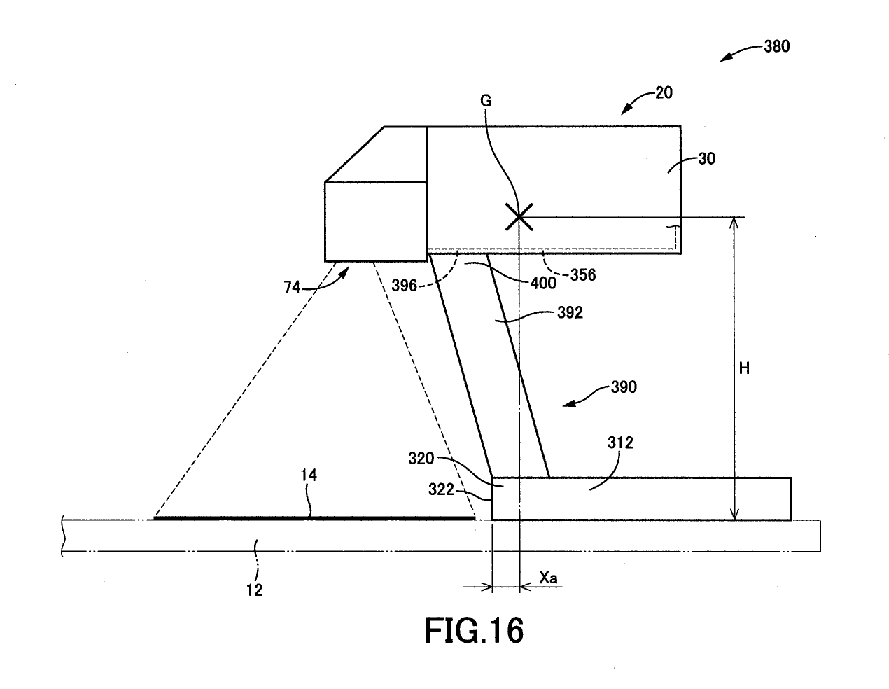

In FIG. 16, there is illustrated in side view a tabletop projector 380 constructed according to the present embodiment. The projector 380 includes a projection device 20 as depicted in FIG. 13, and a supporting device 390 placed on a table 12 to support the projection device 20 in a suspended position over the table 12.

As illustrated in FIG. 16, the supporting device 390 includes a base 312 as depicted in FIG. 13, and a strut 392. The strut 392, differently from the strut 314 depicted in FIG. 13, extends out from a front-side end portion 320 of the base 312 in a forward inclined position with respect to a normal (a vertical line) to the top surface (a horizontal surface) of the base 312.

The projection device 20 is supported at a front end portion 396 (a portion just rearward of an aperture 74) of a bottom wall 356 of a housing 30, by means of a free end portion 400 of the strut 392. The free end portion 400, while acting as a connection between the strut 392 and the projection device 20, is located forward with respect to the center of gravity G of the projection device 20. Likewise, a front end face 322 of the front-side end portion 320 of the base 312 is located forward with respect to the center of gravity G of the projection device 20.

As described above, in the present embodiment, the strut 392 extends out from the front-side end portion 320 of the base 312 in a forward inclined position with respect to a vertical line, as illustrated in FIG. 16.

Accordingly, the projection device 20 of the projector 380 is positioned so as to be located more forwardly of the base 312 than that of the fifth embodiment. That is to say, the aforementioned front-side portion of the projection device 20 has an increased overhang extending forward from the base 312, when viewed in plan view.

Therefore, the present embodiment allows outgoing light from a last-stage lens 76 to be projected onto the screen 14 using not only a portion of the outgoing light which is located forward of an optical axis of the last-stage lens 76 but also a portion of the outgoing light which is located rearward of the optical axis of the last stage lens 76.

Accordingly, in the present embodiment, for light outgoing from the LCD 60 illustrated in FIG. 14, to be focused, a larger-than-half portion of the last-stage lens 76 depicted in FIG. 14 is used, which portion includes not only the front-side one of two halves of the last-stage lens 76 but also at least a part of the rear-side half of the last-stage lens 76.

As a result, in the present embodiment, a maximum projection-region in which a display image can be projected on the screen 14 can be increased with ease greater than when only the front-side half of the last-stage lens 76 can be used.

In other words, the present embodiment makes it easier to eliminate or reduce the constraints on lens design, such as diameters of various lens used in the focusing optical system 70 illustrated in FIG. 14, irrespective of the desired size of the projection region on the screen 14.

An inclination angle at which the strut 392 is inclined forward with respect to a vertical line depends on a combination of a distance Xa of the center of gravity G of the projection de-vice 20 from a front end position of the base 312, as measured in a horizontal direction, and a height H of the center of gravity G of the projection device 20 from the top surface of the table 12.

As illustrated in FIG. 16, the combination of the distance Xa and the height H has been established so that a projected image projected onto the screen 14 by the projection device 20 can be located as close as possible to the front-side end portion 320 of the base 312 without any overlap therewith.

As illustrated in FIG. 16, the center of gravity G of the projection device 20 is located rearward with respect to the front end face 322 of the front-side end portion 320 about which the projection device 20 pivots if it unexpectedly tips forward, and additionally, the center of gravity of the entire projector 380 is also located rearward with respect to the front end face 322 of the front-side end portion 320.

Therefore, the projector 380, similarly with the fifth embodiment, is placed on the table 12 in a dynamically stabilized fashion. As a result, the projector 380, similarly with the fifth embodiment, is prevented from unexpectedly tipping forward.

### EIGHTH ILLUSTRATIVE EMBODIMENT

Next, an eighth illustrative embodiment of the present invention will be described below.

The present embodiment is common to the fifth embodiment with respect to many elements, and is different from the fifth embodiment only with respect to elements concerning a supporting device to support a projection device in a projector.

Therefore, only the different elements of the present embodiment from those of the fifth embodiment will be described below in greater detail, while the common elements of the present embodiment to those of the fifth embodiment will be referenced the same reference numerals or names as those of the fifth embodiment, without redundant description or illustration.

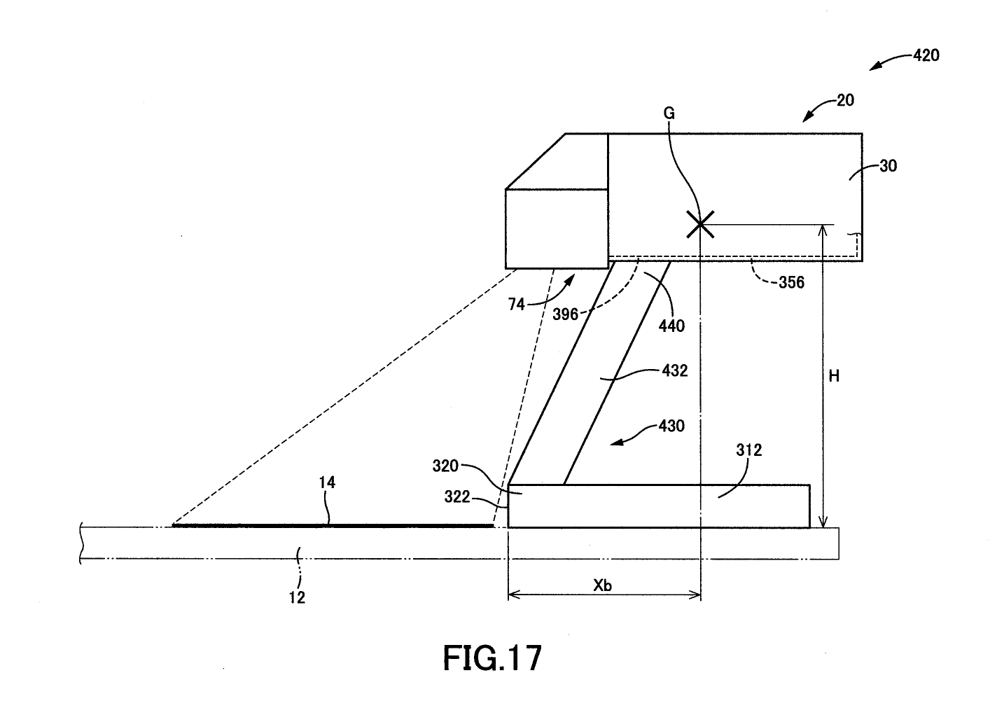

In FIG. 17, there is illustrated in side view a tabletop projector 420 constructed according to the present embodiment. The projector 420 includes a projection device 20 as depicted in FIG. 13, and a supporting device 430 placed on a table 12 to support the projection device 20 in a suspended position over the table 12.

As illustrated in FIG. 17, the supporting device 430 includes a base 312 as depicted in FIG. 13, and a strut 432. The strut 432, differently from the strut 314 depicted in FIG. 13, extends out from a front-side end portion 320 of the base 312 in a rearward inclined position with respect to a vertical line.

The projection device 20 is supported at a front end portion 396 (a portion just rearward of an aperture 74) of a bottom wall 356 of a housing 30, by means of a free end portion 440 of the strut 432. The free end portion 440 is located forward with respect to the center of gravity G of the projection device 20. Likewise, a front end face 322 of the front-side end portion 320 of the base 312 is located forward with respect to the center of gravity G of the projection device 20.

As described above, in the present embodiment, the strut 432 extends out from the front-side end portion 320 of the base 312 in a rearward inclined position with respect to a vertical line, as illustrated in FIG. 17. Accordingly, the projection device 20 of the projector 420 is positioned so as to be located more rearwardly of the base 312 than that of the fifth embodiment.

The present embodiment, similarly with the fifth embodiment, allows a projected image projected onto a screen 14 by the projection device 20 to be located as close as possible to the front-side end portion 320 of the base 312 without any overlap therewith. Therefore, the size of an area occupied by the base 312 together with the projected image on the table 12 can be reduced with greater ease.

An inclination angle at which the strut 432 is inclined rearward depends on a combination of a distance Xb of the center of gravity G of the projection device 20 from the front end position of the base 312, as measured in a horizontal direction, and the height H of the center of gravity G of the projection device 20 from the top surface of the table 12.

As illustrated in FIG. 17, the combination of the distance Xb and the height H has been established so that a projected image projected onto the screen 14 by the projection device 20 can be located as close as possible to the front-side end portion 320 of the base 312 without any overlap therewith.

As described above, in the present embodiment, the center of gravity G of the projection device 20 is located more rearwardly of the base 312 than that of the fifth embodiment, which increases the tendency that the center of gravity of the entire projector 420 is also located more rearward from the base 312 than the center of gravity of the entire projector 300 constructed according to the fifth embodiment.

Therefore, the projector 420 is placed on the table 12 in a dynamically stabilized fashion at a higher level than that of the projector 300 constructed according to the fifth embodiment. As a result, the projector 420 prevents the projector 420 from unexpectedly tipping forward, with greater certainty than that of the projector 300 constructed according to the fifth embodiment.

### NINTH ILLUSTRATIVE EMBODIMENT

Next, a ninth illustrative embodiment of the present invention will be described below.

The present embodiment is common to the fifth embodiment with respect to many elements, and is different from the fifth embodiment only with respect to elements concerning a supporting device to support a projection device in a projector.

Therefore, only the different elements of the present embodiment from those of the fifth embodiment will be described below in greater detail, while the common elements of the present embodiment to those of the fifth embodiment will be referenced the same reference numerals or names as those of the fifth embodiment, without redundant description or illustration.

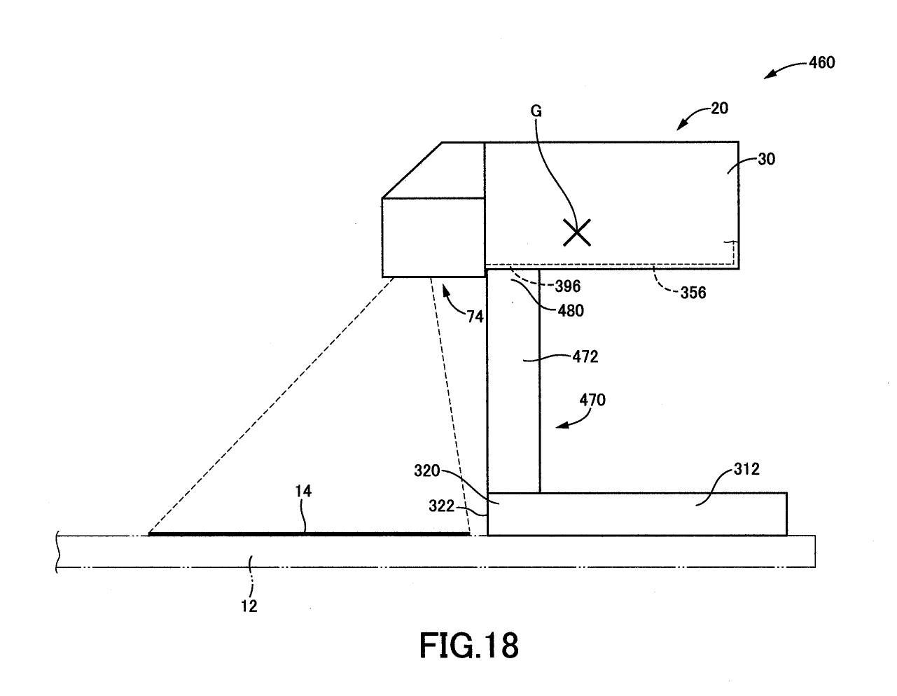

In FIG. 18, there is illustrated in side view a tabletop projector 460 constructed according to the present embodiment. The projector 460 includes a projection device 20 as depicted in FIG. 13, and a supporting device 470 placed on a table 12 to support the projection device 20 in a suspended position over the table 12.

As illustrated in FIG. 18, the supporting device 470 includes a base 312 as depicted in FIG. 13, and a strut 472. The strut 472, differently from the strut 314 depicted in FIG. 13, extends out vertically upwardly from a front-side end portion 320 of the base 312.

The projection device 20 is supported at a front end portion 396 (a portion just rearward of an aperture 74) of a bottom wall 356 of a housing 30, by means of a free end portion 480 of the strut 472. The free end portion 480 is located forward with respect to the center of gravity G of the projection device 20. Likewise, a front end face 322 of the front-side endportion 320 of the base 312 is located forward with respect to the center of gravity G of the projection device 20.

The present embodiment, similarly with the fifth embodiment, allows a projected image projected onto a screen 14 by the projection device 20 to be located as close as possible to the front-side end portion 320 of the base 312 without any overlap therewith. Therefore, the size of an area occupied by the base 312 together with the projected image on the table 12 can be reduced with greater ease.

As illustrated in FIG. 18, in the present embodiment, the strut 472, although, similarly with the eighth embodiment, located forward with respect to the center of gravity G of the projection device 20, the center of gravity G of the projection device 20 is located adequately rearward with respect to the front end face 322 of the front-side end portion 320 of the base 312. It is noted that the center of gravity G of the projection device 20, when it can be assumed that the strut 472 is neglectable small in weight as compared with the projection device 20, coincides with the center of gravity of the entire projector 460.

Therefore, the present embodiment, similarly with the fifth embodiment, allows the projector 460 to be placed on the table 12 in a dynamically stabilized fashion.

### TENTH ILLUSTRATIVE EMBODIMENT

Next, a tenth illustrative embodiment of the present invention will be described below.

The present embodiment is common to the fifth embodiment with respect to many elements, and is different from the fifth embodiment only with respect to elements concerning a supporting device to support a projection device in a projector.

Therefore, only the different elements of the present embodiment from those of the fifth embodiment will be described below in greater detail, while the common elements of the present embodiment to those of the fifth embodiment will be referenced the same reference numerals or names as those of the fifth embodiment, without redundant description or illustration.

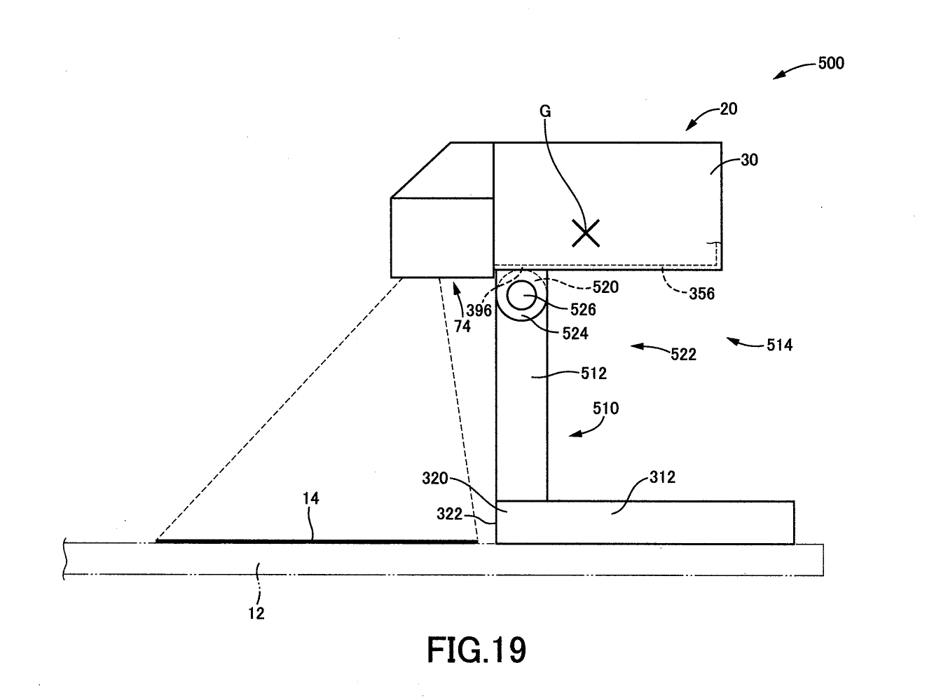

In FIG. 19, there is illustrated in side view a tabletop projector 500 constructed according to the present embodiment. The projector 500 includes a projection device 20 as depicted in FIG. 13, and a supporting device 510 placed on a table 12 to support the projection device 20 in a suspended position over the table 12.

As illustrated in FIG. 19, the supporting device 510 includes a base 312 as depicted in FIG. 13, a strut 512, and a tilt mechanism 514 for adjusting an angle (an angle measured in a vertical plane) of the projection device 20 with respect to the base 312. The strut 512, differently from the strut 314 depicted in FIG. 13, extends out vertically upwardly from a front-side end portion 320 of the base 312. The tilt mechanism 514 is disposed between the strut 512 and a housing 30 of the projection device 20.

The strut 512 includes a free end portion 520. The tilt mechanism 514 includes an engagement device 522 engaging with the free end portion 520 in a pivotable fashion about a pivot axis AR extending in a right-to-left direction. In the presence of the need for locating the pivot axis AR as close as possible to the housing 30, a top face of the free end portion 520 is preferably formed, for example, as a convex surface extending with a semi-cylindrical surface in the right-to-left direction of the projection device 20.

An example of the engagement device 522 is configured to include a pair of engagement pieces 524 and 524 which protrude downward from the housing 30 and which are spaced apart from each other in a direction of the pivot axis AR. The pair of engagement pieces 524 and 524 are pivotably engaged with the free end portion 520 in a position allowing the free end portion 520 to be interposed between the engagement pieces 524 and 524 on both side ends of the free end portion 520.

Through the pair of engagement pieces 524 and 524 and the free end portion 520, a shaft 526 penetrates which extends along the pivot axis AR, whereby the pair of engagement pieces 524 and 524 are coupled to the free end portion 520 in a pivotable fashion about the pivot axis AR.

The pair of engagement pieces 524 and 524 are configured, for example, such that these engagement pieces 524 and 524 extend in parallel to each other and downward from a front end portion 396 (a portion just rearward of an aperture 74) of a bottom wall 356 of the housing 30.

Therefore, the projection device 20 is supported at the free end portion 396 by the supporting device 510. The supporting point is located forward with respect to the center of gravity G of the projection device 20. Likewise, a front end face 322 of the front-side end portion 320 of the base 312 is located forward with respect to the center of gravity G of the projection device 20.

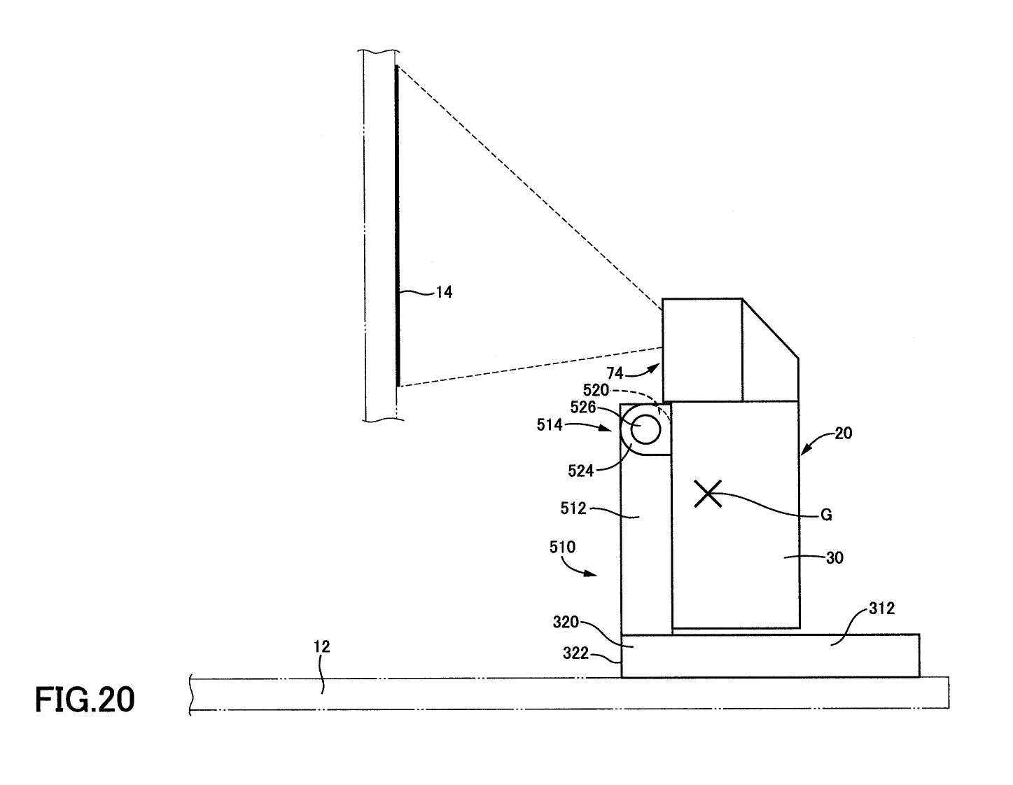

In the present embodiment, the projection device 20 is pivotable about the shaft 526 into any angular position, enabling the projection device 20 to operate for projection onto a screen 14 defined as a projection surface parallel to the table 12, as illustrated in FIG. 19, or to operate for projection onto the screen 14 defined as a projection surface perpendicular to the table 12, as illustrated in FIG. 20.

In the present embodiment, similarly with the fifth embodiment, the center of gravity G of the projection device 20 is located rearward with respect to the front end face 322 of the front-side end portion 320 of the base 312, and additionally, the center of gravity of the entire projector 500 is also located rearward with respect to the front end face 322 of the front-side end portion 320.

Therefore, the projector 500 is placed on the table 12 in such a dynamically stabilized fashion as to prevent the projector 500 from unexpectedly tipping forward.

As illustrated in FIG. 20, it is of course appreciated that the center of gravity G of the projection device 20 is located rearward with respect to the front-side end portion 320 of the base 312, when the projection device 20 is located, for enabling forward projection, in such an angular position as to allow the projection device 20 to face the screen 14 defined as a projection surface perpendicular to the table 12. And it is additionally appreciated that the center of gravity G of the projection device 20 is located lower than when the projection device 20 is located, for enabling downward projection, in such an angular orientation as to allow the projection device 20 to face a projection surface defined parallel to the table 12.

Therefore, in the present embodiment, the dynamical stabilization of the projection device 20 over the table 12 is enhanced and the ability of the projector 500 to be prevented from tipping is also enhanced when the projection device 20 is located, for enabling forward projection, in such an angular position as to allow the projection device 20 to face the screen 14 defined as a projection surface perpendicular to the table 12, as compared with those when the projection device 20 is located, for enabling downward projection, in such an angular orientation as to allow the projection device 20 to face a projection surface defined parallel to the table 12.

Further, in the present embodiment, the overall height of the projector 500 is reduced when the projection device 20 is oriented so as to face the screen 14 defined as a projection surface perpendicular to the table 12, as compared with that when the projection device 20 is oriented so as to face the screen 14 defined as a projection surface parallel to the table 12. The overall-height reduction enables, for example, the projector 500 to be stored in a compact fashion for storage.

### ELEVENTH ILLUSTRATIVE EMBODIMENT

Next, an eleventh illustrative embodiment of the present invention will be described below.

The present embodiment is common to the fifth embodiment with respect to many elements, and is different from the fifth embodiment only with respect to elements concerning a supporting device to support a projection device in a projector.

Therefore, only the different elements of the present embodiment from those of the fifth embodiment will be described below in greater detail, while the common elements of the present embodiment to those of the fifth embodiment will be referenced the same reference numerals or names as those of the fifth embodiment, without redundant description or illustration.

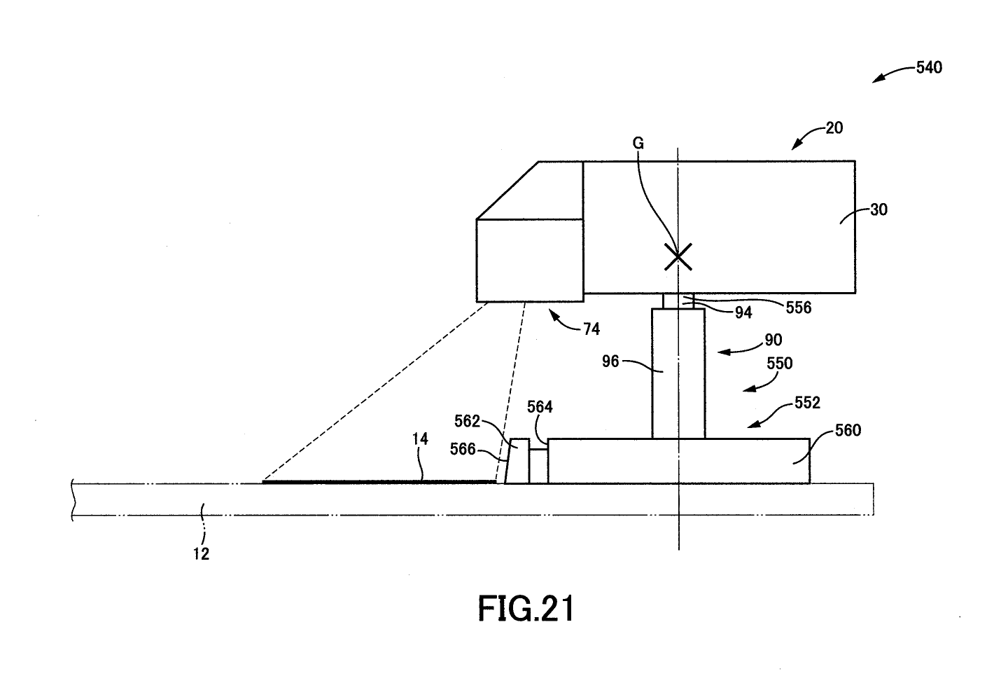

In FIG. 21, there is illustrated in side view a tabletop projector 540 constructed according to the present embodiment. The projector 540 includes a projection device 20 as depicted in FIG. 13, and a supporting device 550 placed on a table 12 to support the projection device 20 in a suspended position over the table 12.

As illustrated in FIG. 21, the supporting device 550 includes a plate-shaped base 552 placed on the table 12 and an extension/retraction mechanism 90 depicted in FIG. 1 which acts as a strut. The extension/retraction mechanism 90 is configured to include: a cylinder 96 which extends out vertically upwardly from a center portion of the base 552; a rod 94 which is fitted into the cylinder 96 in an axially slidable fashion relative thereto; and a locking mechanism 110 depicted in FIG. 3.

The rod 94 is fixedly secured at its free end portion 556 to a housing 30 of the projection device 20. The rod 94 is disposed in the housing 30 such that a center line of the rod 94 passes through the center of gravity G of the projection device 20, when viewed in plan view.

The base 552 is configured to include a body 560 acting as a stationary member, and an elongated anti-tipping member 562 acting as a movable member. The anti-tipping member 562 is mounted to the body 560 so as to extend out from a front end surface 564 of the body 560.

Within the body 560, there is formed an accommodation hole (not shown) which is open at the front end surface 564. The anti-tipping member 562 is accommodated within the accommodation hole so as to be movable in a front-to-rear direction of the base 552 relative thereto.

The anti-tipping member 562 has a top surface 566 which can move away from the front end surface 564 by a variable length. As the top surface 566 of the anti-tipping member 562 moves forward away from the center of gravity G of the projection device 20 and the center of gravity of the projector 540, the dynamic stability of the projector 540 on the table 12 is so enhanced as to prevent the projector 540 from unexpectedly tipping forward.

In the present embodiment, as illustrated in FIG. 21, the smaller the variable length of the extension/retraction mechanism 90 is, the smaller the height of the projection device 20 is. The smaller the height of the projection device 20 is, the smaller the size of a display image projected onto a screen 14 by the projection device 20 is. The smaller the height of the projection device 20 is, the closer the position of the projected image is to the front end surface 564.

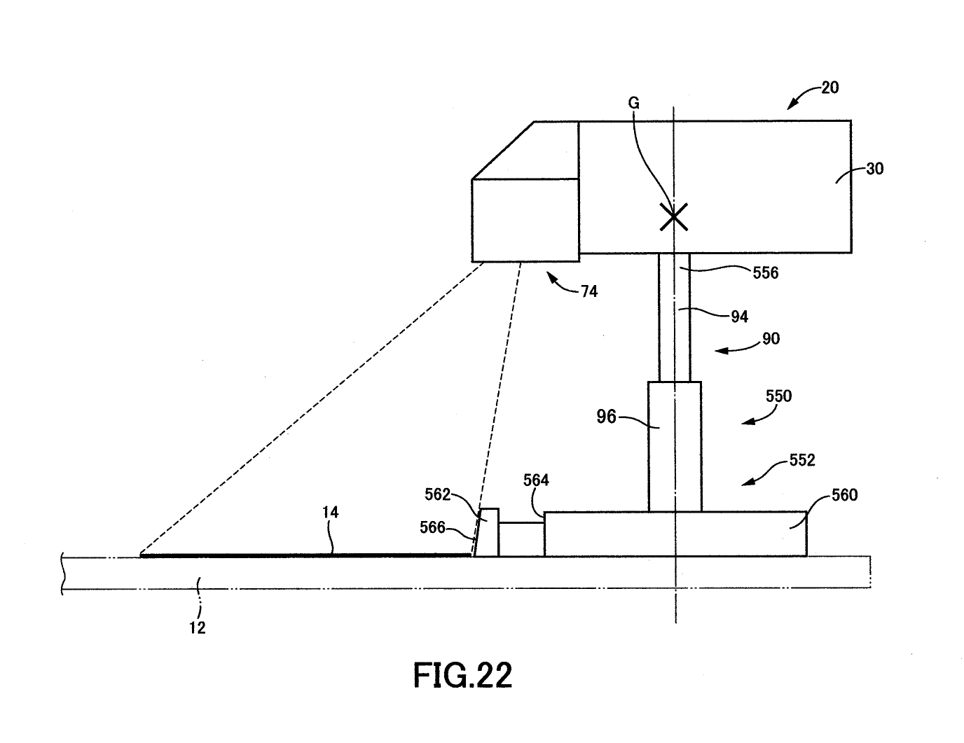

In addition, in the present embodiment, as illustrated in FIG. 22, the larger the length of the extension/retraction mechanism 90 is, the larger the height of the projection device 20 is. The larger the height of the projection device 20 is, the larger the size of a display image projected onto the screen 14 by the projection device 20 is. The larger the height of the projection device 20 is, the farther the position of the projected image is from the front end surface 564.

A user-viewer of the projection device 20 can insert the anti-tipping member 560 into the aforementioned accommodation hole or withdraw the anti-tipping member 560 from the aforementioned accommodation hole, depending on the position of an image which has been projected with a variable enlargement/reduction scale which varies with the variable height of the projection device 20, so as to prevent the projected image from overlapping with the top surface 566 of the anti-tipping member 562.

This adaptive action would maximize the ability of the anti-tipping member 562 to prevent the projection device 20 from tipping, without producing any overlap or any wasteful clearance between the projected image and the anti-tipping member 562.

### TWELFTH ILLUSTRATIVE EMBODIMENT

Next, a twelfth illustrative embodiment of the present invention will be described below.

The present embodiment is common to the fifth embodiment with respect to many elements, and is different from the fifth embodiment only with respect to elements concerning a projection device of a projector to project an image.

Therefore, only the different elements of the present embodiment from those of the fifth embodiment will be described below in greater detail, while the common elements of the present embodiment to those of the fifth embodiment will be referenced the same reference numerals or names as those of the fifth embodiment, without redundant description or illustration.

In the fifth embodiment, as illustrated in FIG. 13, outgoing light from the projection device 20 is projected slightly obliquely onto the screen 14. That is to say, a portion of the outgoing light from the projection device 20 which passes through a proximate position to the front end face 322 of the base 312 travels in an oblique direction with respect to a vertical line, when viewed in side view. The portion of the outgoing light will be referred to as “proximate portion” below.

Accordingly, once the height of the projection device 20 has been adjusted as a result of user's expansion/retraction of a strut 314 in a similar manner with the eleventh embodiment, user's replacement of the original strut 314 with another strut having a different length, or the like, then the aforementioned proximate portion of the outgoing light from the projection device 20 is projected onto the screen 14 at a projection point movable fore and aft as a function of the height of the projection device 20.

As a result, a dependent change is also made in the size of a front-to-rear clearance left between the front end face 322 and an adjacent edge of a resulting projected image.

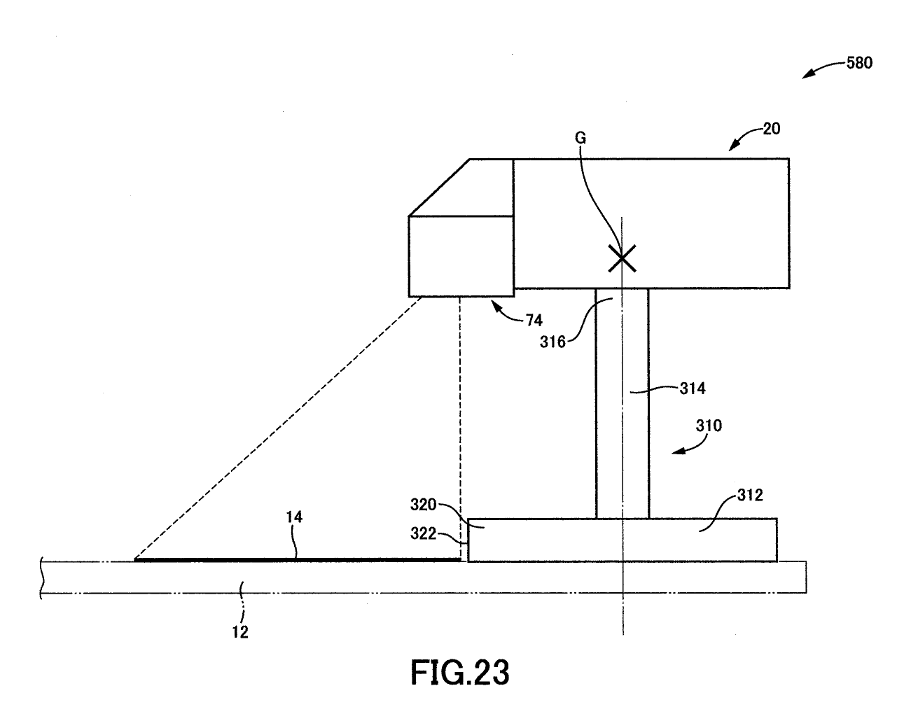

In contrast, in the present embodiment, a focusing optical system 70 is configured to allow the aforementioned proximate portion of the outgoing light from the projection device 20, to be projected vertically onto the screen 14, as illustrated in FIG. 23.

As a result, the aforementioned proximate portion of the outgoing light from the projection device 20 is projected onto the screen 14 at a projection point which is fixed in position irrespective of whether the projection device 20 is higher or lower in height.

The present embodiment, therefore, allows the designers to design the exterior configuration (especially the exterior configuration of the supporting device 310) of the projector 580, without taking account of possible changes in the position of the projection point resulting from changes in the height of the projection device 20. Accordingly, the present embodiment allows the designers to design the exterior configuration of the projector 580 with an improved degree of design flexibility.

Further, in the present embodiment, a horizontal distance between the center of gravity of the projector 580 and the front end face 322 of the base 312 remains unchanged irrespective of changes in the height of the projection device 20. Therefore, in the present embodiment, the dynamical stabilization of the projector 580 over the table 12 also remains unchanged irrespective of changes in the height of the projection device 20.

It is added that a projection surface onto which a display image is to be projected by a projector, although taking the form of the screen 14 in the illustrative embodiments described above, is not limited to the screen 14 in carrying out the present invention, and may alternatively take the form of the surface of the table 12 per se, for example.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A projector supportable on a support surface which is defined as at least a surface coplanar with or parallel to a projection surface, for use in projecting imaging light representative of a display image onto the projection surface, to thereby display the display image on the projection surface, the projector comprising:
a projection device arranged to project the imaging light toward the projection surface, to thereby focus the image onto the projection surface as a projected image; and
a supporting device arranged, when placed on the support surface, to support the projection device such that a distance between an exit face at which the imaging light exits the projection device and the projection surface is adjustable.

2. The projector according to claim 1, wherein the projection device is configured to include a focusing optical system arranged to focus the projected image onto the projection surface using optical properties of the focusing optical system, the optical properties including such deep depth-of-field that allows the projected image to be substantially maintained in viewer-acceptable focus over a full adjustable-range of the distance.

3. The projector according to claim 1, wherein the projection device is configured to include a focus adjuster arranged to optically adjust focus of the projected image, and the projector further comprises a controller arranged to control the focus adjuster based on the distance, to thereby automatically adjust the focus of the projected image.

4. The projector according to claim 3, wherein the focus adjuster is electrically powered, and the controller is arranged to electrically detect the distance and electrically control the focus adjuster based on the detected distance.

5. The projector according to claim 3, wherein the focus adjuster is mechanically powered, and the controller is arranged to transfer to the focus adjuster, a relative mechanical-movement between a stationary member and a movable portion of the projector which moves as the distance changes, to thereby automatically adjust the focus of the projected image.

6. The projector according to claim 1, used in a position allowing an optical axis of the imaging light exiting the projection device to be oriented perpendicular to the projection surface.

7. The projector according to claim 1, wherein the supporting device is configured to include a base which is to be placed on the support surface and support the projection device, when the base is placed on the support surface, such that the base and the projected image are arrayed on the support surface so as to be closely spaced from each other.

8. The projector according to claim 7, wherein the supporting device is configured to include:
the base to be placed on the support surface; and
a strut extending out from the base, and
the strut is arranged to support the projection device, when the base is placed on the support surface, such that the base and the projected image are arrayed on the support surface so as to be closely spaced from each other.

9. The projector according to claim 8, wherein the support surface is defined as a horizontal surface, and
the strut is configured to extend from the base to the projection device and support the projection device in a position allowing a center of gravity of the projection device to be located on a center line of the strut.

10. The projector according to claim 8, wherein the support surface is defined as a horizontal surface,
the projection device is configured to extend along the support surface and include a front-side portion from which the imaging light is emitted and a rear-side portion, and
the strut is configured to extend from the base to the projection device and support the projection device in a position allowing the center of gravity of the projection device to be located, when viewed in plan view, on the same side as the front-side portion of the projection device, with respect to a connection point between the projection device and the strut.

11. The projector according to claim 8, wherein the support surface is defined as a horizontal surface,
the projection device is configured to extend along the support surface and include a front-side portion from which the imaging light is emitted and a rear-side portion, and
the strut is configured to extend from the base to the projection device so as to be inclined toward the front-side portion of the projection device with respect to a normal to the support surface, the strut being arranged to support the projection device in a position allowing the center of gravity of the projection device to be located, when viewed in plan view, on the same side as the rear-side portion of the projection device, with respect to a connection point between the projection device and the strut.

12. The projector according to claim 8, wherein the support surface is defined as a horizontal surface,
the projection device is configured to extend along the support surface and include a front-side portion from which the imaging light is emitted and a rear-side portion, and
the strut is configured to extend from the base to the projection device so as to be inclined toward the rear-side portion of the projection device with respect to a normal to the support surface, the strut being arranged to support the projection device in a position allowing the center of gravity of the projection device to be located, when viewed in plan view, on the same side as the rear-side portion of the projection device, with respect to a connection point between the projection device and the strut.

13. The projector according to claim 8, wherein the support surface is defined as a horizontal surface,
the projection device is configured to extend along the support surface and include a front-side portion from which the imaging light is emitted and a rear-side portion, and
the strut is configured to extend from the base to the projection device so as to be parallel to a normal to the support surface, the strut being arranged to support the projection device in a position allowing the center of gravity of the projection device to be located, when viewed in plan view, on the same side as the rear-side portion of the projection device, with respect to a connection point between the projection device and the strut.

14. The projector according to claim 7, wherein the projection device is arranged to project the imaging light such that a portion of the imaging light emitted from the projection device, which portion is proximate to the base, is projected from the projection device onto the projection surface perpendicularly.

15. The projector according to claim 7, further comprising a tilt mechanism configured to pivotably couple the projection device to the strut.

16. The projector according to claim 7, wherein the projection device is configured to extend along the support surface and include a front-side portion from which the imaging light is emitted and a rear-side portion, and
the base is configured to include a main body and a movable member disposed at a front end portion of the main body which is proximate to the projected image, the movable member being movable relative to the main body in a front-to-rear direction of the projection device.
